(19) United States
(12) Patent Application Publication
(10) Pub. No.: US 2025/0372618 A1
(43) Pub. Date: Dec. 4, 2025

(54) ELECTRODE MATERIAL, ITS PREPARATION AND USE IN SODIUM-ION BATTERY

(71) Applicant: City University of Hong Kong, Kowloon (HK)

(72) Inventors: Chun Sing Lee, Kowloon (HK); Tianyi Song, Kowloon (HK); Chen Chen Wang, Kowloon (HK)

(21) Appl. No.: 18/732,762

(22) Filed: Jun. 4, 2024

(51) Int. Cl. H01M 4/36; H01M 4/02; H01M 4/525; H01M 4/58; H01M 10/054

(52) U.S. Cl. CPC H01M 4/364; H01M 4/525; H01M 4/5825; H01M 10/054; H01M 2004/028

(57) ABSTRACT

An electrode material for a sodium-ion battery includes a mixed-phase structure of sodium nickel-manganese oxide associated with sodium selenate, wherein the sodium nickel-manganese oxide has a general formula of NaₓNi_{y}Mn_{z}O₂, wherein 0.3<x<0.95, 0<y<0.5, 0.5<z<1, and y+z=1. A method for preparing the electrode material and use of the electrode material in a sodium-ion battery are also addressed.

### TECHNICAL FIELD

The present invention relates to an electrode material, for example, particularly, but not exclusively, an electrode material comprising a mixed-phase structure for sodium-ion battery and a preparation method and use of the electrode material in sodium-ion battery.

### BACKGROUND OF THE INVENTION

Sodium-ion batteries (SIBs) have been considered as competitive candidates for next-generation batteries. Among various battery components, it is believed that cathode materials are critical in determining the cost, capacity, and output voltage of SIBs.

Among various cathode materials, layered transition metal oxides, particularly P3-type layered transition metal oxides, such as those rich in manganese and/or nickel, have attracted much attention. However, it is believed that this kind of cathode materials may suffer from slab gliding upon repeated desodiation/sodiation (i.e., extraction/insertion of sodium ion during repeated charging and discharging cycles), which may induce disastrous structure degradation and thus fast capacity decay and deteriorated kinetics such as limited rate capacity.

Several strategies have been developed to address the above problem. In particular, it is believed that mixed-phase strategies such as P3-type layered transition metal oxides introduced with other redox-active phases would enhance the performance of cathode material, such as the specific capacity thereof. However, it is believed that it remains challenging for such a mixed-phase strategy to achieve cycling stability and rate capability that meet practical application needs.

The present invention thus seeks to eliminate or at least mitigate such shortcomings by providing a new or otherwise improved mixed-phase electrode material for SIBs.

### SUMMARY OF THE INVENTION

In a first aspect of the present invention, there is provided an electrode material for a sodium-ion battery comprising a mixed phase structure of sodium nickel-manganese oxide associated with sodium selenate, wherein the sodium nickel-manganese oxide has a general formula of NaₓNi_{y}Mn_{z}O₂, wherein 0.3<x<0.95, 0<y<0.5, 0.5<z<1, and y+z=1.

Optionally, the sodium nickel-manganese oxide has a layered structure and is arranged in a P3-type (ABBCCA) stacking lattice.

In an optional embodiment, the sodium nickel-manganese oxide is arranged as a hexagonal lattice.

Optionally, the hexagonal lattice has a space group of R3m.

In an optional embodiment, the sodium selenate is arranged as an orthorhombic lattice.

Optionally, the orthorhombic lattice has a space group of Fddd.

In an optional embodiment, the mixed-phase structure includes an interface formed by the sodium selenate and the sodium nickel-manganese oxide.

Optionally, the sodium selenate is redox inert and is resistant to structural change during the charging and discharging cycle, thereby suppressing the P3-O3 phase transition of the sodium nickel-manganese oxide during the charging and discharging cycle.

It is optional that the sodium nickel-manganese oxide and the sodium selenate have a phase fraction ratio of >50 wt. %.

In an optional embodiment, the sodium nickel-manganese oxide is about 83 wt. % to about 90 wt. % of the mixed phase structure.

It is optional that the sodium nickel-manganese oxide is about 83.8 wt. %, about 86.7 wt. %, or about 89.8 wt. % of the mixed-phase structure. In an optional embodiment, the sodium selenate is about 7 wt. % to about 14 wt. % of the mixed-phase structure. Optionally, the sodium selenate is about 7.3 wt. %, about 11.3 wt. %, or about 13.6 wt. % of the mixed-phase structure.

It is optional that the mixed-phase structure further includes NiO, which is about 2 wt. % to about 3 wt. % of the mixed phase structure.

In an optional embodiment, the mixed-phase structure comprises Na_{0.47}Ni_{0.23}Mn_{0.77}O₂/Na₂SeO₄, Na_{0.45}Ni_{0.2}Mn_{0.8}O₂/Na₂SeO₄, Na_{0.53}Ni_{0.22}Mn_{0.78}O₂/Na₂SeO₄ or a combination thereof.

In a second aspect of the present invention, there is provided a method for preparing the electrode material in accordance with the first aspect, comprising the steps of: providing a solid mixture comprising a sodium source, a manganese source, a nickel source, and a selenium source; heating the solid mixture in a furnace at a first temperature under predetermined atmosphere and pressure; heating the solid mixture at a second temperature which is different from the first temperature to obtain the electrode material; and isolating the electrode material at a third temperature which is different from the first temperature and the second temperature.

Optionally, the method further comprises the steps of: providing a grounded mixture of the sodium source, the manganese source, the nickel source, and the selenium source; and converting the grounded mixture into a pellet.

It is optional that both heating steps are carried out under a reduced pressure and an O₂ atmosphere, or under an atmospheric pressure and an air atmosphere.

Optionally, the step of isolation includes cooling down the electrode material to the third temperature and storing it under an inert gas atmosphere.

In an optional embodiment, the sodium source, the manganese source, the nickel source, and the selenium source are CH₃COONa, Mn₂O₃, NiO, and Se, respectively.

Optionally, the sodium source, the manganese source, the nickel source, and the selenium source have a mole ratio of Na:Mn:Ni:Se=9:10:3:1-3.

It is optional that the method further comprises the step of increasing the temperature of the furnace to the first temperature at a rate of about 1-5° C./min, followed by maintaining the furnace at the first temperature for about 2-6 hours.

It is optional that the method further comprises the step of increasing the first temperature to the second temperature at a rate of about 1-5° C./min, followed by maintaining the furnace at the second temperature for about 10-15 hours before carrying out the step of cooling down to the third temperature.

In an optional embodiment, the first temperature, the second temperature, and the third temperature are about 300-400° C. (such as about 350° C.), about 650-750° C. (such as about 650° C.), and about 190-210° C. (such as 200° C.), respectively.

In a third aspect of the present invention, there is provided a sodium-ion battery comprising an electrode that comprises the electrode material in accordance with the first aspect, wherein the electrode is a cathode.

In an optional embodiment, the sodium-ion battery is a half-coin cell with an anode of sodium metal.

In an optional embodiment, the sodium-ion battery is a full-coin cell with an anode of pre-sodiated hard carbon.

Optionally, an active mass ratio of the cathode and the anode is about 1.9:1.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1A is a table summarizing the elemental composition of P3-Na_{0.48}Ni_{0.2}Mn_{0.8}O₂(NMNO), P3-Na_{0.47}Ni_{0.23}Mn_{0.77}O₂/Na₂SeO₄ (NMNO/NSO-1), P3-Na_{0.45}Ni_{0.2}Mn_{0.8}O₂/Na₂SeO₄ (NMNO/NSO-2), and P3-Na_{0.53}Ni_{0.22}Mn_{0.78}O/Na₂SeO₄ (NMNO/NSO-3) confirmed by inductively coupled plasma optical emission spectrometer (ICP-OES);

FIG. 2A shows XRD Rietveld refinements plots for NMNO/NSO-2;

FIG. 2B shows XRD Rietveld refinements plots for NMNO;

FIG. 2C shows XRD Rietveld refinements plots for NMNO/NSO-1;

FIG. 2D shows XRD Rietveld refinements plots for NMNO/NSO-3;

FIG. 3A is a table summarizing the lattice parameters of NMNO/NSO-2 after Rietveld refinement;

FIG. 3B is a set of tables summarizing the structural parameters and atomic position of NMNO/NSO-2 after Rietveld refinement;

FIG. 3C is a table summarizing the lattice parameters of NMNO after Rietveld refinement;

FIG. 3D is a table summarizing the structural parameters and atomic position of NMNO after Rietveld refinement;

FIG. 3E is a table summarizing the lattice parameters of NMNO/NSO-1 after Rietveld refinement;

FIG. 3F is a set of tables summarizing the structural parameters and atomic position of NMNO/NSO-1 after Rietveld refinement;

FIG. 3G is a table summarizing the lattice parameters of NMNO/NSO-3 after Rietveld refinement;

FIG. 3H is a set of tables summarizing the structural parameters and atomic position of NMNO/NSO-3 after Rietveld refinement;

FIG. 4 shows the comparison of Raman spectra between NMNO and NMNO/NSO-2;

FIG. 5A shows the scanning electron microscope (SEM) image of the as-prepared NMNO/NSO-2 with a magnification scale of 2 μm;

FIG. 5B shows the SEM image of the as-prepared NMNO/NSO-2 with a magnification scale of 5 μm;

FIG. 6A shows the SEM image of the as-prepared NMNO with a magnification scale of 2 μm;

FIG. 6B shows the SEM image of the as-prepared NMNO with a magnification scale of 5 μm;

FIG. 7A shows the XPS spectra of O1s for the NMNO/NSO-2 powder sample at different Ar⁺ etching depths;

FIG. 7B shows the XPS spectra of Na1s for the NMNO/NSO-2 powder sample at different Ar⁺ etching depths;

FIG. 7C shows the XPS spectra of CIs for the NMNO/NSO-2 powder sample at different Ar⁺ etching depths;

FIG. 7D shows the XPS spectra of Mn 2p for the NMNO/NSO-2 powder sample at different Ar⁺ etching depths;

FIG. 7E shows the XPS spectra of Ni 2p for the NMNO/NSO-2 powder sample at different Ar⁺ etching depths;

FIG. 7F shows the XPS spectra of Se 3d_{5/2} for the NMNO/NSO-2 powder sample at different Ar⁺ etching depths;

FIG. 8 shows the transmission Electron Microscopy-energy dispersive spectroscopy (TEM-EDS) mapping for NMNO/NSO-2;

FIG. 9A shows the TEM image of NMNO/NSO-2, illustrating the co-existence of the NMNO (region A) and NSO (region B) phases;

FIG. 9B shows the enlarged TEM images corresponding to the regions A and B in FIG. 9A;

FIG. 10A shows the XPS spectra of Ni 2p_{3/2} for the NMNO/NSO-2 powders at the pristine and after Ar⁺ etching states;

FIG. 10B shows the XPS spectra of Mn 2p_{3/2} for the NMNO/NSO-2 powders at the pristine and after Ar⁺ etching states;

FIG. 10C shows the XPS spectra of Se 3d_{5/2} for the NMNO/NSO-2 powders at the pristine and after Ar⁺ etching states;

FIG. 11 shows the selected galvanostatic curves for NMNO and NMNO/NSO-2 cathodes at 50 mA g⁻¹;

FIG. 12A shows the CV curves at the scan rate of 0.1 mV s⁻¹ for NMNO cathode;

FIG. 12B shows the CV curves at the scan rate of 0.1 mV s⁻¹ for NMNO/NSO-2 cathode;

FIG. 13 shows the cycling performance and coulombic efficiency comparison between NMNO and NMNO/NSO-2 cathodes at 400 mA g⁻¹;

FIG. 14 shows the normalized capacity at different current densities for NMNO and NMNO/NSO-2 cathodes;

FIG. 15 shows the capacity-voltage profiles at different current densities for the NMNO/NSO-2 cathode. The dash-dotted line represents the capacity-voltage profile for the NMNO/NSO-2 cathode at 0.05 A g⁻¹ after cycling at 6.4 A g⁻¹;

FIG. 16 shows the cycling performance comparison of NMNO and NMNO/NSO with different contents of Se;

FIG. 17A shows the cycling performance and coulombic efficiency comparison between NMNO/NSO-2 and NMNO at 2000 mA g⁻¹;

FIG. 17B shows the cycling performance of NMNO/NSO-2/Na half-cell at the current density of 50 mA g⁻¹;

FIG. 18 shows the cycling performance and coulombic efficiency comparison plot within 1.7-4.3 V between NMNO and NMNO/NSO-2 cathodes;

FIG. 19 shows the comparison plot of cycling performance and rate capability for reported P3-type cathodes and NMNO/NSO-2 cathode;

FIG. 20A is part of a table summarizing the electrochemical performance of reported P3-type cathodes corresponding to FIG. 19;

FIG. 20B is part of a table summarizing the electrochemical performance of reported P3-type cathodes corresponding to FIG. 19;

FIG. 20C is part of a table summarizing the electrochemical performance of reported P3-type cathodes corresponding to FIG. 19;

FIG. 20D is part of a table summarizing the electrochemical performance of reported P3-type cathodes and the NMNO/NSO-2 cathode corresponding to FIG. 19;

FIG. 21 shows the comparison plot of cycling performance and rate capability for some reported P2-type and O3-type cathodes;

FIG. 22A is part of a table summarizing the electrochemical performance of some reported P2-type and O3-type cathodes corresponding to FIG. 21;

FIG. 22B is part of a table summarizing the electrochemical performance of some reported P2-type and O3-type cathodes corresponding to FIG. 21;

FIG. 22C is part of a table summarizing the electrochemical performance of some reported P2-type and O3-type cathodes and the NMNO/NSO-2 cathode corresponding to FIG. 21;

FIG. 23A shows the GITT profiles of the initial cycle for NMNO and NMNO/NSO-2 cathodes;

FIG. 23B shows the calculated Na⁺ diffusion coefficients (D_{Na+}) for NMNO and NMNO/NSO-2 cathodes during the charge/discharge process;

FIG. 24A shows the voltage vs. time profiles of a selected single titration upon charge process for the GITT experiment of NMNO/NSO-2;

FIG. 24B shows the voltage vs. time profiles of a selected single titration upon discharge process for the GITT experiment of NMNO/NSO-2;

FIG. 25A is a schematic diagram illustrating the Na⁺ diffusion pathways from one Na site to the nearest neighbor vacancy in NMNO;

FIG. 25B is a schematic diagram illustrating the Na⁺ diffusion pathways from one Na site to the nearest neighbor vacancy in NMNO/NSO-2;

FIG. 26A shows the corresponding diffusion barriers along various diffusion pathways of NMNO and NMNO/NSO-2;

FIG. 26B shows the comparison plot of diffusion barriers for various diffusion pathways of NMNO and NMNO/NSO-2;

FIG. 27 shows the partial and Total density of states of NMNO and NMNO/NSO-2;

FIG. 28A shows the first cycle of the voltage profile within 1.5-4 V for the NMNO half-cell;

FIG. 28B shows the corresponding 2D contour plots of in-situ XRD patterns for NMNO;

FIG. 28C shows the corresponding lattice parameters evolution for NMNO half-cell;

FIG. 29A shows the first cycle of voltage profile within 1.5-4 V for the NMNO/NSO-2 half-cell;

FIG. 29B shows the corresponding 2D contour plots of in-situ XRD patterns for NMNO/NSO-2. #Represents Na₂SeO₄ and * represents Be window;

FIG. 29C shows the corresponding lattice parameters evolution for NMNO/NSO-2 half-cell;

FIG. 30A shows the relative phase fraction changes involved in P3, O3, and O3′ phases for NMNO;

FIG. 30B shows the relative phase fraction changes involved in P3, O3, and O3′ phases for NMNO/NSO-2;

FIG. 31 shows the in-situ XRD patterns during the charge and discharge process for the Na₂SeO₄ phase in NMNO/NSO-2 cathode;

FIG. 32A shows the XPS spectra of Mn 2p_{3/2} after Ar⁺ etching 400 s for NMNO/NSO-2 cathodes at different stages;

FIG. 32B shows the XPS spectra of Ni 2p_{3/2} after Ar⁺ etching 400 s for NMNO/NSO-2 cathodes at different stages;

FIG. 32C shows the XPS spectra of Se 3d_{5/2} after Ar⁺ etching 400 s for NMNO/NSO-2 cathodes at different stages;

FIG. 33A shows the Ex-situ Raman spectra of the NMNO cathodes at the pristine, fully charged, and fully discharged states;

FIG. 33B shows the Ex-situ Raman spectra of the NMNO/NSO-2 cathodes at the pristine, fully charged, and fully discharged states;

FIG. 34 is a schematic diagram illustrating the NMNO/NSO-2/Hard carbon full-cell configuration in accordance with an embodiment of the present invention;

FIG. 35A shows the galvanostatic curve of the hard carbon in Na metal half-cell within 0.01-1.5 V;

FIG. 35B shows the dQ/dV curve of the hard carbon in Na metal half-cell within 0.01-1.5 V;

FIG. 35C shows the cycling performance curve of the hard carbon in Na metal half-cell within 0.01-1.5 V;

FIG. 36 shows the voltage-capacity curves of the NMNO/NSO-2 cathode and hard carbon anode in Na metal half-cells, respectively;

FIG. 37 shows the CV curves of the full-cell during the first four cycles at 0.2 mV s⁻¹ scan rate;

FIG. 38 shows the rate performance of the full-cell at various current densities;

FIG. 39 shows the rate performance comparison plot, where P2/O3-NaNMS represents P2/O3-Na_{2/3}Ni_{1/3}Mn_{1/3}Sn_{1/3}O₂, NMNCMO represents [Na_{0.67}Zn_{0.05}]Ni_{0.18}Cu_{0.1}Mn_{0.67}O₂, NMNM-1 represents Na_{0.84}Mn_{0.67}Ni_{0.2}Mg_{0.1}□_{0.03}O₂ (where the symbol “□” refers to the vacancy in transition metal site), NCLNM4 represents P2-Na_{0.75}Ca_{0.04}[Li_{0.1}Ni_{0.2}Mn_{0.67}]O₂; ZnFeHCF-2 represents NaₓZn_{y}Fe_{1-y}[Fe(CN)₆], NNMMO-HNA represents P2-Na_{0.67}Ni_{0.23}Mg_{0.1}Mn_{0.67}O₂ with hierarchical one-dimensional nanostructure composed of nanoplate subunits assembly, NLCMO represents Na_{0.72}Li_{0.14}Cu_{0.15}Mn_{0.71}O₂, and P2-NaMNNb represents Na_{0.78}Ni_{0.31}Mn_{0.67}Nb_{0.02}O₂;

FIG. 40 shows the cycling performance curves of the full-cell at 50 mA g⁻¹;

FIG. 41 shows the cycling performance curves of the full-cell at 1000 mA g⁻¹; and

FIG. 42 shows the capacity fading percentage for per cycle comparison plot, where P2-NZNCMO represents [Na_{0.67}Zn_{0.05}]Ni_{0.18}Cu_{0.1}Mn_{0.67}O₂, NaNM@Zr represents P2-type Na_{2/3}Ni_{1/3}Mn_{2/3}O₂@ZrO₂, P3-NaLNMT represents P3-Na_{2/3}Li_{1/9}Ni_{5/18}Mn_{1/2}Ti_{1/6}O₂, ZnFeHCF-2 represents NaₓZn_{y}Fe_{1-y}[Fe(CN)₆], O3-NNAMO represents O3-NaNi_{0.45}Al_{0.1}Mn_{0.45}O₂; P2/O3-NaNMS represents P2/O3-Na_{2/3}Ni_{1/3}Mn_{1/3}Sn_{1/3}O₂, LLS-NaNCMM represents P2@P3 integrated spinel Na_{0.5}Ni_{0.1}Co_{0.15}Mn_{0.65}Mg_{0.1}O2, P2-NaMNNb represents Na_{0.78}Ni_{0.31}Mn_{0.67}Nb_{0.02}O₂, and P2-NNCMB represents Na_{0.67}Ni_{0.3}Co_{0.1}Mn_{0.6}O_{1.94}(BO₃)_{0.02}.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

Without wishing to be bound by theory, the inventors have, through their own research, trials, and experiments, devised that introducing a structurally stable, inert, particularly redox inert Na⁺ conductive phase to a P3-type sodium transition metal oxide phase may enable the construction of a mixed-phase structure in a nanoscale. In particular, it is believed that such a mixed-phase structure may result in an interface with an electric field therein, which may lead to a synergistic effect that effectively lowers Na⁺ diffusion coefficients and suppresses P3-O3 phase transitions of the sodium transition metal oxide phase during deep sodiation, resulting in a significant enhancement in rate capability and cycling stability.

In the first aspect of the present invention, there is provided with an electrode material for a sodium-ion battery comprising a mixed-phase structure of sodium nickel-manganese oxide associated with sodium selenate, wherein the sodium nickel-manganese oxide has a general formula of NaₓNi_{y}Mn_{z}O₂, wherein 0.3<x<0.95, 0<y<0.5, 0.5<z<1, and y+z=1.

In some embodiments, sodium nickel-manganese oxide may have a layered structure. Preferably, the sodium nickel-manganese oxide may be arranged in a P3-type stacking lattice. That is, sodium nickel-manganese oxide may have a stacking sequence of ABBCCA. It is believed that a P3-type stacking lattice may provide large open channels in the prismatic Na layers, leading to fast Na⁺ transport kinetics. It is also believed that a lower synthesis temperature (e.g., <750° C.) (as compared to >850° C. for P2- and O3-type homologs) is required for the synthesis of the P3-type stacking lattice, thereby reducing energy consumption in practical applications.

In some embodiments, the sodium nickel-manganese oxide may be arranged as a hexagonal lattice, particularly a hexagonal lattice with a space group of R3m. The sodium selenate may also be arranged as a lattice. In some embodiments, the sodium selenate may be arranged as an orthorhombic lattice, in particular, an orthorhombic lattice with a space group of Fddd.

In some embodiments, there may be an interface between and formed by the sodium selenate and the sodium nickel-manganese oxide. It is believed that such an interface may achieve a synergistic function in boosting Na⁺ diffusion and charge transfer kinetics and enhancing structural stability, resulting in a significant enhancement in the rate capability and cycling stability of the electrode material. For example, the interfaces between the sodium selenate and the sodium nickel-manganese oxide of the mixed-phases structure may enable more Na⁺ diffusion pathways with lower diffusion barriers by virtue of its built-in electric field. It is believed that the sodium selenate is redox inert and is resistant to structural change during the charging and discharging cycle. Thus, it may act as an inert buffer phase for the sodium nickel-manganese oxide phase, which tends to undergo an (irreversible) P3-O3 phase transition during the charging and discharging cycle as a result of the transition metal layer gliding during such a cycle. In other words, the sodium selenate may suppress the P3-O3 phase transition of the sodium nickel-manganese oxide during the charge and discharge cycle.

In some embodiments, the sodium nickel-manganese oxide and the sodium selenate have a phase fraction ratio of >50 wt. %. In some example embodiments, the sodium nickel-manganese oxide may be about 83 wt. % (e.g., from 82.7 wt. % . . . 82.75 wt. % . . . 82.85 wt. % . . . 82.9 wt. % . . . 83 wt. % . . . 83.02 wt. % . . . 83.06 wt. % . . . 83.1 wt. % . . . to 83.3 wt. %) to about 90 wt. % (e.g., from 89.7 wt. % . . . 89.75 wt. % . . . 89.85 wt. % . . . 89.9 wt. % . . . 90 wt. % . . . 90.02 wt. % . . . 90.06 wt. % . . . 90.1 wt. % . . . to 90.3 wt. %) of the mixed-phase structure, whereas the sodium selenate may be about 7 wt. % (e.g., from 6.7 wt. % . . . 6.75 wt. % . . . 6.85 wt. % . . . 6.9 wt. % . . . 7 wt. % . . . 7.02 wt. % . . . 7.06 wt. % . . . 7.1 wt. % . . . to 7.3 wt. %) to about 14 wt. % (e.g., from 13.7 wt. % . . . 13.75 wt. % . . . 13.85 wt. % . . . 13.9 wt. % . . . 14 wt. % . . . 14.02 wt. % . . . 14.06 wt. % . . . 14.1 wt. % . . . to 14.3 wt. %) of the mixed-phase structure. In some particular embodiments, the sodium nickel-manganese oxide may be about 83.8 wt. %, about 86.7 wt. %, or about 89.8 wt. % of the mixed-phase structure, whereas the sodium selenate may be about 7.3 wt. %, about 11.3 wt. % or about 13.6 wt. % of the mixed-phase structure.

In some other embodiments, the mixed-phase structure may further include NiO, which is about 2 wt. % (e.g., 1.8 wt. % . . . 1.85 wt. % . . . 1.88 wt. %, 1.9 wt. % . . . 1.94 wt. % . . . 1.99 wt. %, 2 wt. % . . . 2.02 wt. % . . . 2.06 wt. % . . . to 2.1 wt. %) to about 3 wt. % (e.g., 2.8 wt. % . . . 2.85 wt. % . . . 2.88 wt. %, 2.9 wt. % . . . 2.94 wt. % . . . 2.99 wt. %, 3 wt. % . . . 3.02 wt. % . . . 3.06 wt. % . . . to 3.1 wt. %) of the mixed-phase structure. It is believed that the amount of NiO present in the mixed-phase structure is trace, and it has a negligible influence on the electrochemical performance of the mixed-phase structure and the electrode material.

In some particular embodiments, the mixed-phase structure may have a general formula of NaₓNi_{y}Mn_{z}O₂/Na₂SeO₄, with x, y, z as being defined herein. In some further particular embodiments, the mixed-phase structure may have the above general formula with x=0.47-0.53, y=0.2-0.23, z=0.77-0.8, where y+z=1. As specific embodiments, the mixed-phase structure may comprise Na_{0.47}Ni_{0.23}Mn_{0.77}O₂/Na₂SeO₄, Na_{0.45}Ni_{0.2}Mn_{0.8}O₂/Na₂SeO₄, Na_{0.53}Ni_{0.22}Mn_{0.78}O₂/Na₂SeO₄ or a combination thereof.

The method for preparing the electrode as described is now described herein. The method may comprise the steps of: providing a solid mixture comprising a sodium source, a manganese source, a nickel source, and a selenium source; heating the solid mixture in a furnace such as a tube furnace, muffle furnace and the like, at a first temperature under a predetermined atmosphere and pressure; heating the solid mixture at a second temperature which is different from the first temperature to obtain the electrode material; and isolating the electrode material at a third temperature which is different from the first temperature and the second temperature.

The solid mixture may be of any shape and dimension in accordance with practical needs. In some embodiments where the solid mixture may comprise a pellet, the method may further comprise the steps of: providing a grounded mixture of the sodium source, the manganese source, the nickel source, and the selenium source; and converting the grounded mixture into a pellet. In these embodiments, the sodium source, the manganese source, the nickel source, and the selenium source may be in powder form and may be grounded with a mortar and pestle for, e.g., 1 hour, followed by pressing the grounded powder mixture into a pellet. The pellet may then be transferred to a tube furnace, such as a vacuum tube furnace, for subsequent heat treatment(s).

The sodium source, the manganese source, the nickel source, and the selenium source may be CH₃COONa, Mn₂O₃, NiO, and Se, respectively. In particular, the sodium source, the manganese source, the nickel source, and the selenium source may have a mole ratio of 9:10:3:1-3, such as 9:10:3:1, 9:10:3:1.2, 9:10:3:1.5, 9:10:3:1.8, 9:10:3:2, 9:10:3:2.2, 9:5:10:2.5, 9:10:3:2.7, 9:10:3:3, 9:10:3:3.1 and the like.

In some embodiments, both heating steps may be carried out under a reduced pressure and an O₂ atmosphere or under an atmospheric pressure and an air atmosphere. In some particular embodiments, for example, before commencing the heat treatment processes, the furnace may be evacuated to a vacuum of 0 mbar. After that, the method may further comprise the step of increasing temperature of the tube furnace to the first temperature, such as about 300-400° C., particularly about 350° C. (e.g., from 348.1° C. . . . 348.6° C., 349.2° C. . . . 349.5° C. . . . 349.8° C. . . . 350° C. . . . 350.2° C. . . . 350.5° C. . . . to 351° C.) at a rate of about 1-5° C./min, particularly about 3° C./min (e.g., from 2.9° C./min . . . 2.95° C./min . . . 2.99° C./min, 3° C./min . . . 3.02° C./min . . . 3.08° C./min to 3.1° C./min), followed by maintaining the tube furnace at the first temperature for about 2-6 hours (e.g., about 2 hours).

After heating the solid mixture, such as the pellet as described herein at the first temperature, the method may further comprise the step of increasing the first temperature to the second temperature, such as about 650-750° C., particularly about 650° C. (e.g., from 648.1° C. . . . 648.6° C., 649.2° C. . . . 649.5° C. . . . 649.8° C. . . . 650° C. . . . 650.2° C. . . . 650.5° C. . . . to 651° C.) at a rate of about 1-5° C./min, particularly about 3° C./min, followed by maintaining the tube furnace at the second temperature for about 10-15 hours (e.g., about 10 hours).

Upon the above-mentioned heat treatment processes are completed, the electrode material as described herein may be formed. At this stage, the method may commence the step of isolating the electrode material. In particular, the step of isolation may include cooling down the electrode material to the third temperature and storing it under an inert gas atmosphere. For example, the furnace may be allowed to cool down naturally to the third temperature such about 190-210° C., particularly about 200° C. (e.g., from 198.1° C. . . . 198.6° C. . . . 199.2° C. . . . 199.5° C. . . . 199.8° C. . . . 200° C. . . . 200.2° C. . . . 200.5° C. . . . to 201° C.) under vacuum pumping, followed by collecting the cooled electrode material and transferring it to a container filled with an inert gas for storage. Optionally, the collected electrode material may be stored in a container filled with an inert gas, such as a glove box filled with argon gas.

Further pertained to the present invention is a sodium-ion battery comprising an electrode comprising the electrode material as described herein, wherein the electrode is a cathode.

The sodium-ion battery may comprise cylindrical batteries, rectangular batteries, camera batteries, button/coin cells, and the like. In some embodiments, the sodium-ion battery may be a half-coin cell with an anode of sodium metal. In some other embodiments, the sodium-ion battery may be a full-coin cell with an anode of pre-sodiated hard carbon.

In the above embodiments, the anode may be configured to have electrical communication with the cathode. In particular, the anode and the cathode may be immersed in an electrolyte such as 1M NaPF₆ in diglyme and separated by a separator such as a glass fiber. In the embodiments where the sodium-ion battery is a full-coin cell, the cathode, and the anode may have an active mass ratio of about 1.9:1.

It is believed that the sodium-ion battery, including an electrode with the electrode material as described herein, may have an electrochemical performance superior or at least comparable to some counterparts with P3-, P2-, and O3-type cathodes. In some example embodiments, the sodium-ion battery, such as the half coin cell as described herein, may have a high reversible discharge capacity of 83.9 mAh g⁻¹ at an ultrahigh current density of 6400 mA g⁻¹ and excellent long cycling stability (75% capacity retention over 1000 cycles at 2000 mA g⁻¹). In some other example embodiments, the sodium-ion battery, such as the full coin cell as described herein, may have a high-power density (78.6 W kg⁻¹) and unexpectedly long cycling performance (82.8% capacity retention after 1000 cycles at 1000 mA g⁻¹). Details of the electrochemical performance of the sodium-ion battery will be discussed later in the part of the present disclosure.

Hereinafter, the present invention is described more specifically by way of examples, but the present invention is not limited thereto.

### EXAMPLES

### Characterization and Methods

### Structural Characterization

X-ray diffraction (XRD) patterns were collected on a SmartLab (Rigaku, Japan) Diffractometer with a Cu Kα radiation source (λ₁=1.540593 Å, λ₂=1.544414 Å) over the 10°-80° 2θ range. XRD refinement was carried out using structure analysis software (GSAS 2) based on the Rietveld method. Compositions of the as-synthesized samples were determined using Inductively Coupled Plasma Atomic Emission Spectroscopy (ICP-OES, PE optima 6000). High-resolution transmission electron microscope (TEM) images and elemental mapping were conducted on a JEOL JEM 2100F operated at 200 kV. XPS spectra were recorded by a SPECS Phoibos 150 hemispherical electron energy analyzer with a base vacuum lower than 10-9 mbar. Raman spectra were collected with a Renishaw 2000 Raman system with a 633 nm laser source. In-situ XRD studies were carried out on a custom-designed Swagelok cell, loaded with ˜6-7 mg active materials and an X-ray transparent beryllium window, cycled at 30 mA/g between 1.5 to 4 V.

### DFT Calculations

All calculations were performed by the plane-wave ultrasoft pseudopotential method using CASTEP based on the density functional theory (DFT). The local density approximation (LDA, CA-PZ) functional was adopted to treat the exchange and correlation energy. The cutoff energy for the plane-wave basis set was chosen to be 280 eV. The Monkhorst-Pack k point density with 1×2×1 was used in the Brillouin zone. The convergence criteria of energy, force, stress, and displacement were respectively set as 5.0×10⁻⁵ eV per atom, 0.1 eV Å¹, 0.2 GPa, and 5.0×10⁻³ Å. Spin-polarization was considered throughout all calculations. The Na diffusion energy barriers in NMNO and the NMNO/NSO composites were calculated by the complete linear synchronous transit/quadratic synchronous transit (LST/QST) method.

### Electrochemical Measurements

Working electrodes were prepared by mixing the active materials, conductive Ketjen Carbon Black, and polyvinylidene difluoride (PVDF) with a ratio of 8:1:1 in NMP solvents and cast on carbon-coated Al foils. The prepared electrodes were dried at 80° C. under vacuum for 12 h and cut into 11 mm circle pieces. Anode was prepared by mixing commercial hard carbon, super P carbon black, and sodium carboxymethyl cellulose (CMC) binders in distilled water with a ratio of 8:1:1 and dried at 60° C. under vacuum for 12 h and cut into 12 mm circle pieces.

To assemble the full battery, the hard carbon anode was pre-sodiated by directly contacting the sodium metal disk moistened with 1M NaPF₆ in diglyme (G2) electrolyte for 2-8 h. Half and full-cells using respectively sodium metal and the pre-sodiated hard carbon anodes were assembled into CR-2032 coin cells in an Ar-filled glove box (H₂O, O₂<0.1 ppm). Glass fiber (Whatman, GF/A) was used as separators. 1M NaPF₆ in diglyme (G2) was used as electrolyte.

Charge and discharge tests were performed on a NEWARE test system (CT4008) over 1.5-4.0 and 1.5-3.9 V for half and full-cells, respectively. Diffusivity of sodium ion was determined by both the galvanostatic intermittent titration technique (GITT) using repeated current pulses for 10 min at a current density of 20 mA g⁻¹ followed by relaxation for 2 h. Cyclic voltammetry (CV) at a scan rate of 0.1 mV s⁻¹ was performed on the IviumStat electrochemical workstation.

### Na-Ion Diffusion Coefficient Calculation:

### GITT Method

$${D}_{{Na}^{+}} = \frac{4}{π τ} {( \frac{{m}_{B} {V}_{m}}{{M}_{B} A} )}^{2} {( \frac{Δ {E}_{S}}{Δ {E}_{τ}} )}^{2} , τ << \frac{{L}^{2}}{D} ; \qquad Equation l$$

where, D_{Na}_{⁺} (cm² s⁻¹) represents the chemical diffusion coefficient, V_{M} (cm³ mol⁻¹), m_{B}, and M_{B} are the molar volume, weight, and molar weight of the active materials, respectively. A and τ (s) represent the surface area of the electrode and the testing time in each step, and ΔEs, ΔEτ are the quasi-equilibrium potential and the change of cell voltage E during the current pulse, respectively.

### Example 1A

### Synthesis of NMNO

NMNO (P3-Na_{0.48}Ni_{0.2}Mn_{0.8}O₂) was synthesized by a simple solid-state method. The raw materials ratios for NMNO are CH₃COONa (AR, Aladdin):Mn₂O₃ (AR, Macklin):NiO (AR, Aladdin)=7:5:3 (in mole).

A mixture of these raw materials in powder forms were hand grounded for 1 h and pressed into pellets, and then transferred to a vacuum tube furnace (Lindberg/Blue M, STF54459C). The tube was first evacuated to a vacuum of 0 mbar and then heated at a ramping rate of 3° C./min. After reaching 350° C., the temperature was held for 2 hours. The temperature was then ramped again at the same rate to 650° C. and maintained for 10 hours. The tube was cooled down naturally under vacuum pumping. At 200° C., the NMNO sample were collected and immediately transferred to an Ar-filled glove box.

### Example 1B

### Synthesis of NMNO/NSO-1/2/3

NMNO/NSO-2 (P3-Na_{0.45}Ni_{0.2}Mn_{0.8}O₂/Na₂SeO₄) was synthesized by a simple solid-state method. The ratios of the raw materials are CH₃COONa:Mn₂O₃:NiO:Se (99.5%, STREM)=9:5:3:2.

A mixture of these raw materials in powder forms was hand grounded for 1 h and pressed into pellets, and then transferred to a vacuum tube furnace (Lindberg/Blue M, STF54459C). The tube was first evacuated to a vacuum of 0 mbar and then heated at a ramping rate of 3° C./min. After reaching 350° C., the temperature was held for 2 hours. The temperature was then ramped again at the same rate to 650° C. and maintained for 10 hours. The tube was cooled down naturally under vacuum pumping. At 200° C., the NMNO/NSO-2 sample were collected and immediately transferred to an Ar-filled glove box.

For exploring the influence of NSO contents to the electrochemical performance of the mixed-phase structure, NMNO/NSO-1 (P3-Na_{0.47}Ni_{0.23}Mn_{0.77}O₂/Na₂SeO₄) and NMNO/NSO-3 (P3-Na_{0.53}Ni_{0.22}Mn_{0.78}O₂/Na₂SeO₄) samples were synthesized at the same conditions as NMNO/NSO-2 except that the Se contents were 1 (in mole) for NMNO/NSO-1 and 3 (in mole) for NMNO/NSO-3, respectively. In particular, it was found that the volatile selenium can promote the evaporation of sodium and lead to the formation of the Na₂SeO₄ (NSO) phase.

### Example 2

### Structure Characterization

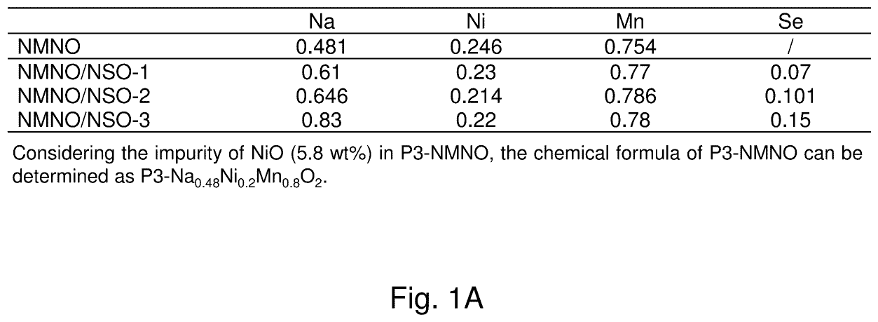

Compositions of NMNO, NMNO/NSO-2, NMNO/NSO-1, and NMNO/NSO-3 are respectively determined to be Na_{0.48}Ni_{0.2}Mn_{0.8}O₂, Na_{0.45}Ni_{0.2}Mn_{0.8}O₂/Na₂SeO₄, Na_{0.47}Ni_{0.23}Mn_{0.77}O₂/Na₂SeO₄, and Na_{0.53}Ni_{0.22}Mn_{0.78}O₂/Na₂SeO₄ (FIG. 1A) via inductively coupled plasma optical emission spectroscopy (ICP-OES).

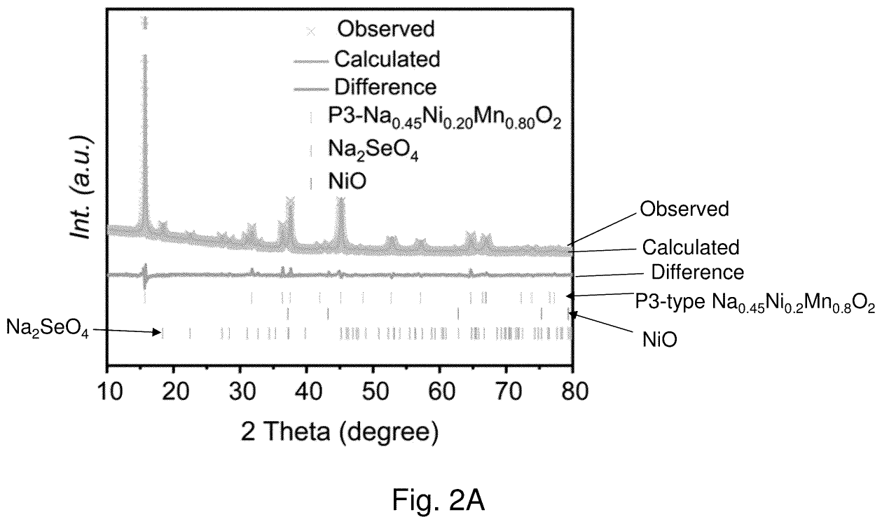

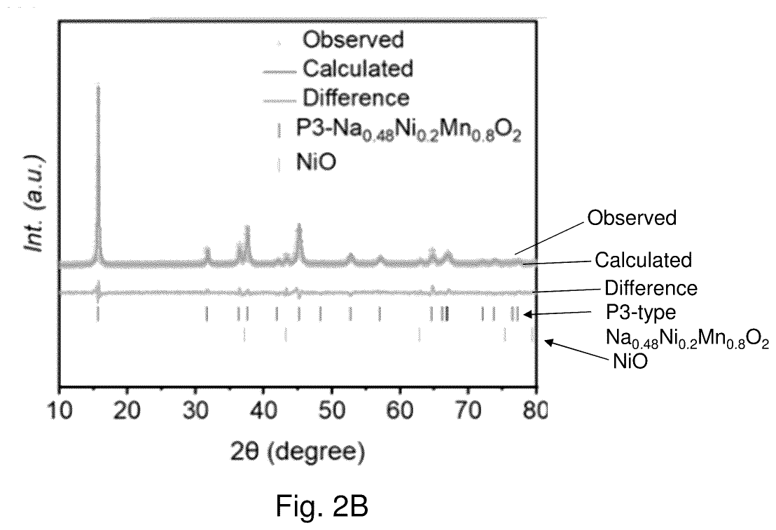

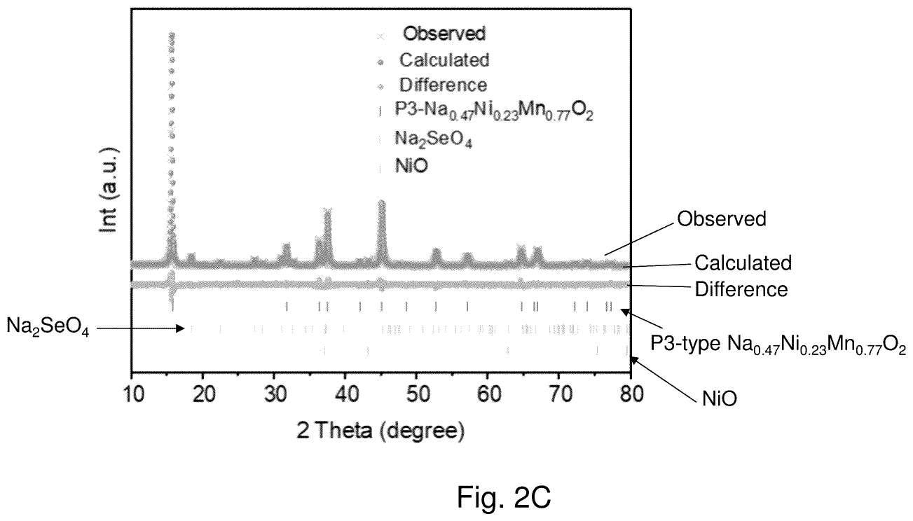

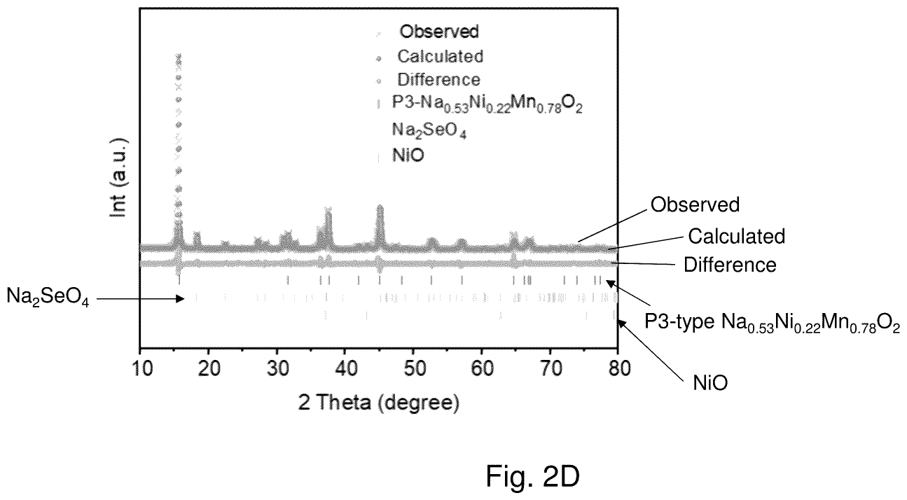

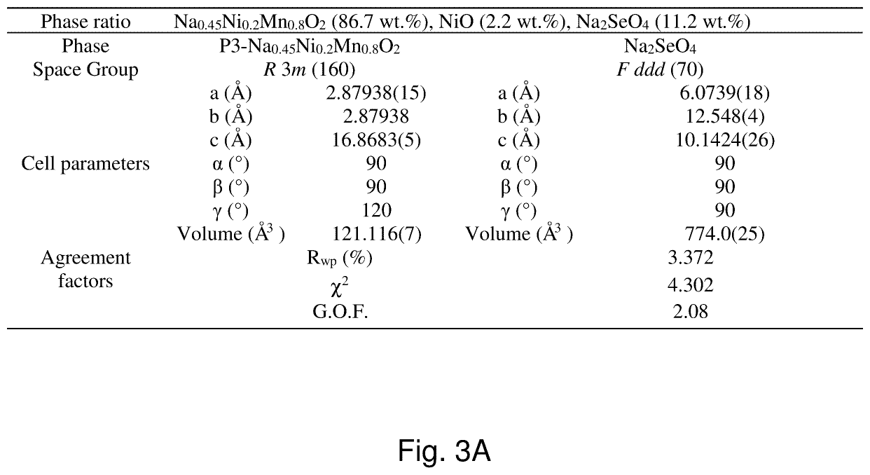

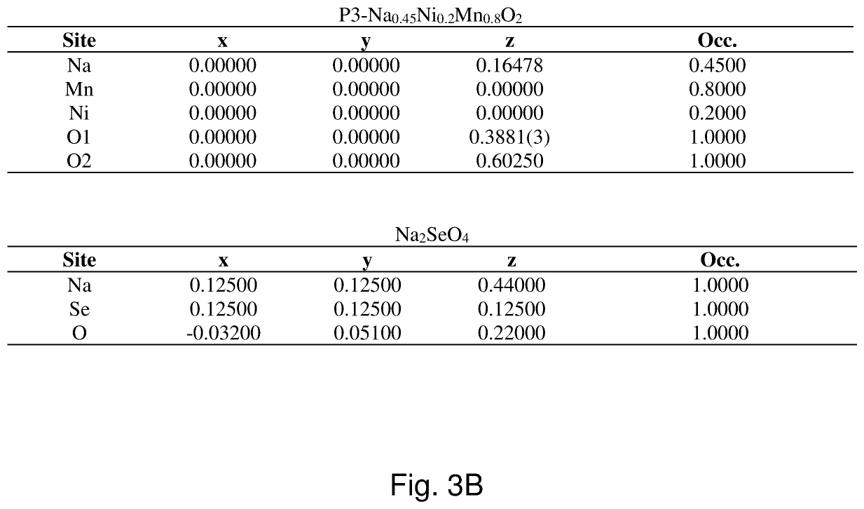

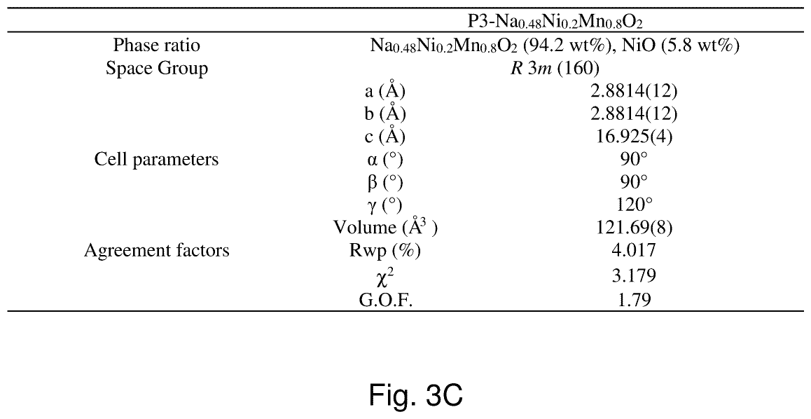

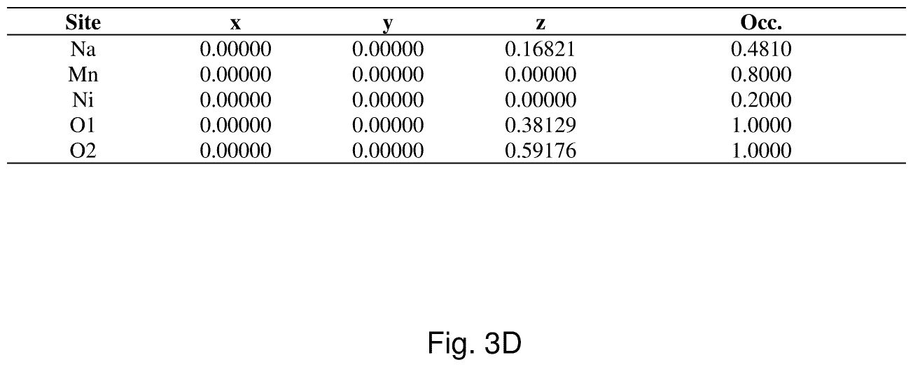

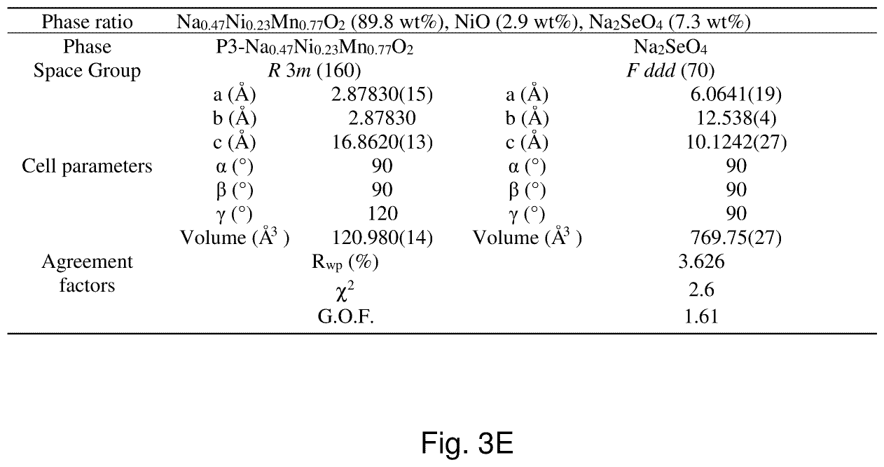

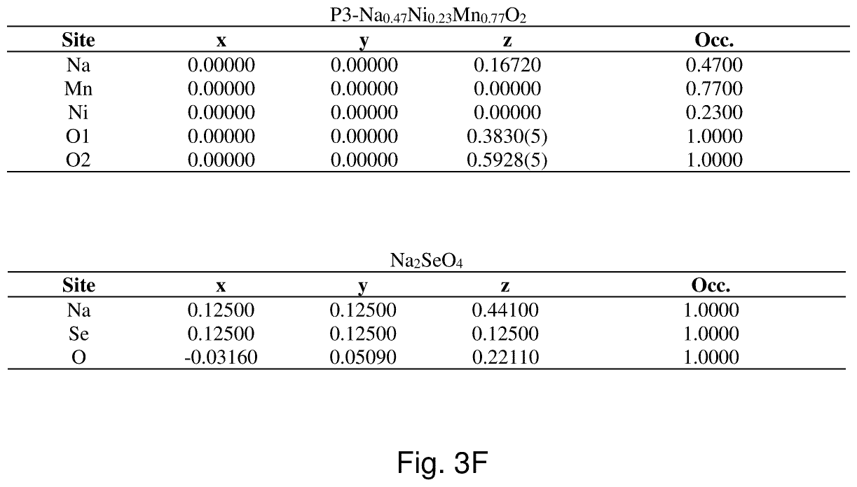

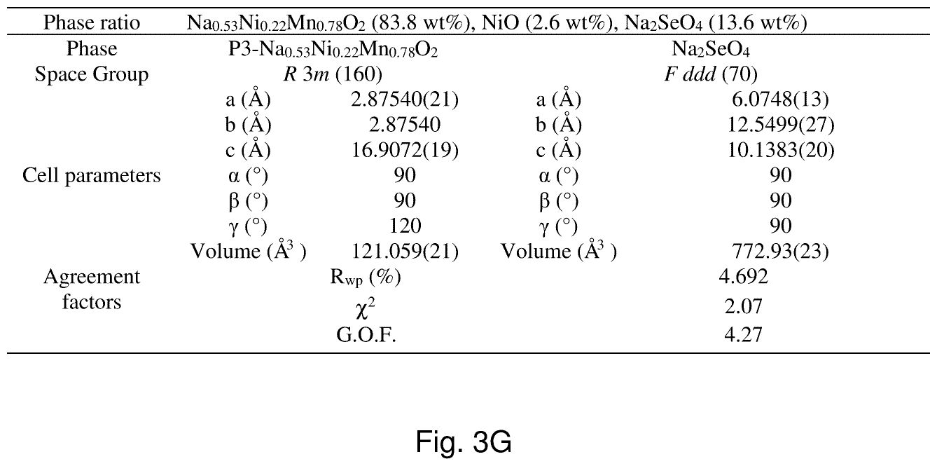

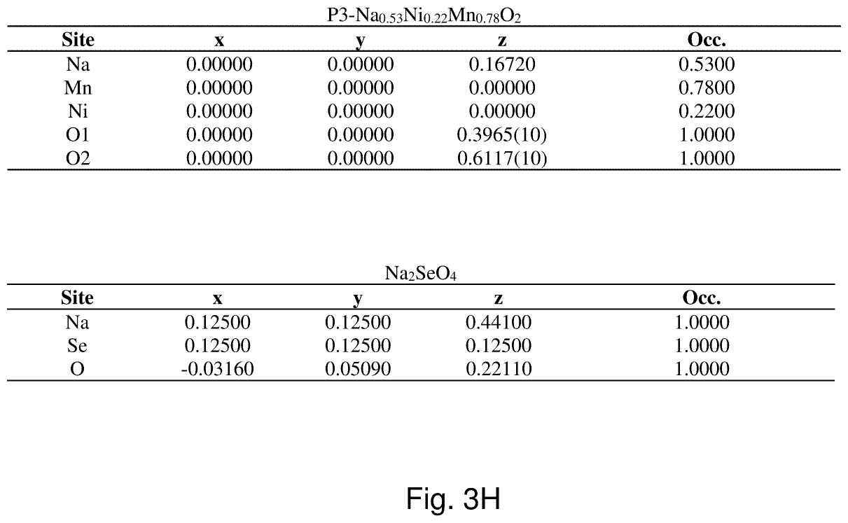

According to Rietveld refinement of X-ray diffraction (XRD) (FIGS. 2A-2D and 3A-3H), the structure of NMNO can be indexed as the hexagonal P3 phase with a space group of R3m. For mixed-phase structure NMNO/NSO-2, NMNO/NSO-1, and NMNO/NSO-3, the extra Na₂SeO₄ phase can be indexed as an orthorhombic Fddd network phase. The NMNO/NSO-2 mixed-phase structure/material comprises 86.7 wt. % P3-Na_{0.45}Ni_{0.2}Mn_{0.8}O₂, 11.2 wt. % Na₂SeO₄, and 2.2 wt. % NiO impurity. At the same time, NMNO/NSO-1 and NMNO/NSO-3 consist of Na_{0.47}Ni_{0.23}Mn_{0.77}O₂ (89.8 wt. %), NiO (2.9 wt. %), Na₂SeO₄ (7.3 wt. %), and Na_{0.53}Ni_{0.22}Mn_{0.78}O₂ (83.8 wt. %), NiO (2.6 wt. %), Na₂SeO₄ (13.6 wt. %), respectively. It is believed that the trace amount of NiO impurities is hard to be eliminated during the synthesis for most layer oxide cathodes, and it is also believed that this impurity phase typically has little influence on electrochemical performance.

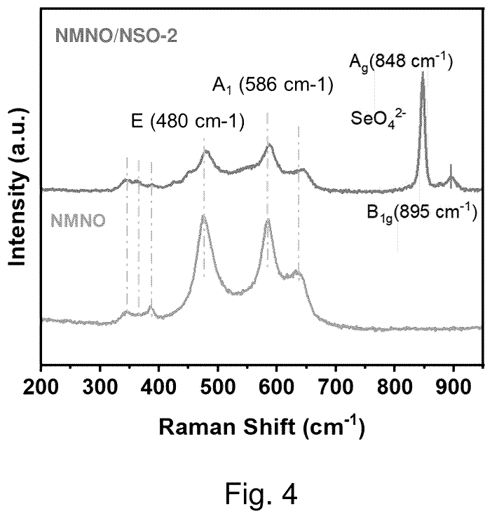

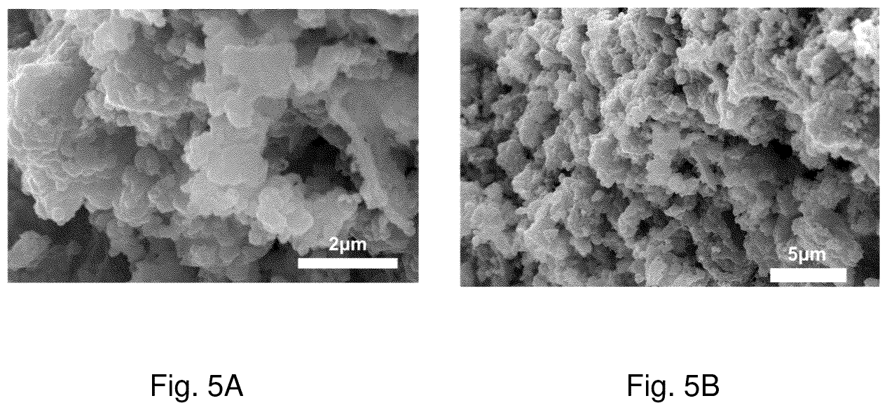

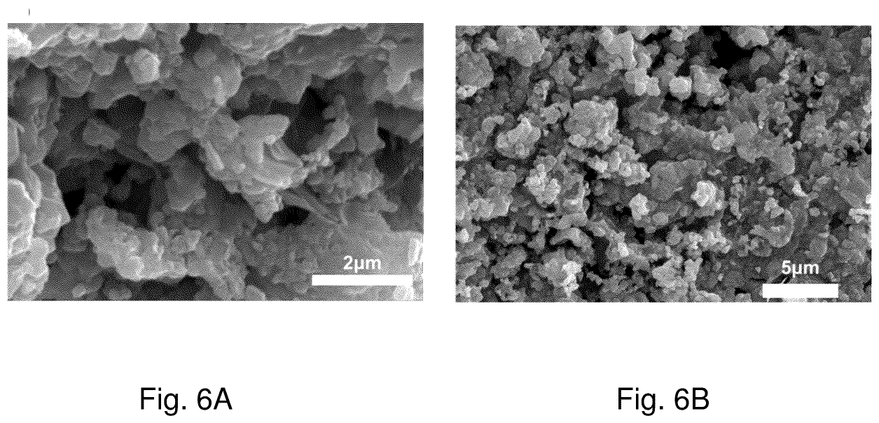

Raman spectra of NMNO and NMNO/NSO-2 in FIG. 4 agree well with the XRD results, presenting the characteristic bands from the P3 phase (˜480 cm⁻¹ for E mode and 586 cm⁻¹ for A₁ mode) and SeO₄²⁻ (˜848 cm⁻¹ for A_{g} mode and ˜895 cm⁻¹ for B_{1g} mode, respectively). The characteristic bands of E and A₁ modes for NMNO/NSO-2 exhibit a blue shift compared to NMNO, indicating that the transition metal slab thickness has decreased, probably due to the reduced Na contents. The as-prepared NMNO/NSO-2 shows a smoother surface than NMNO (FIGS. 5A-5B and 6A-6B).

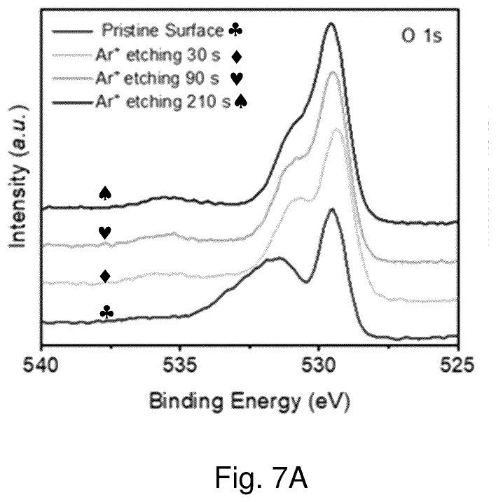

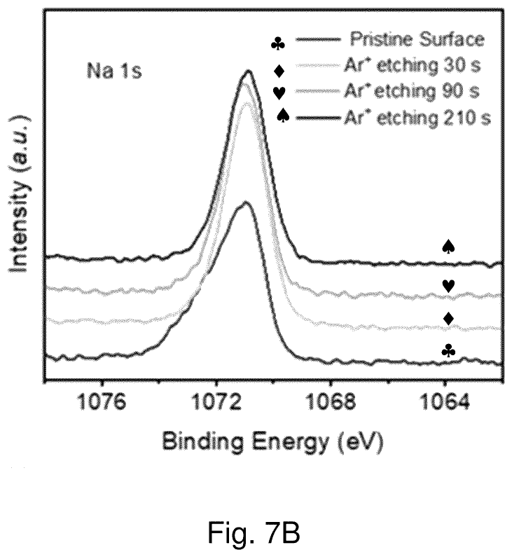

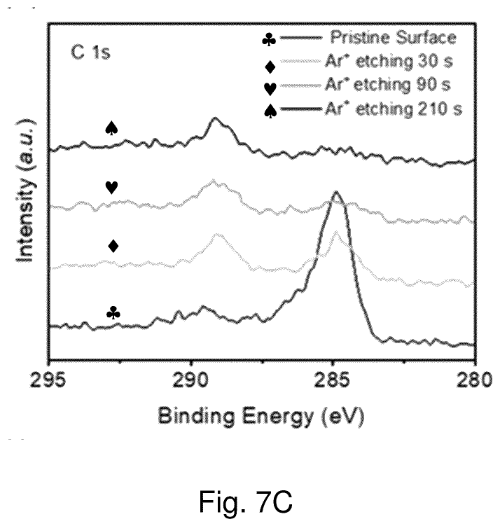

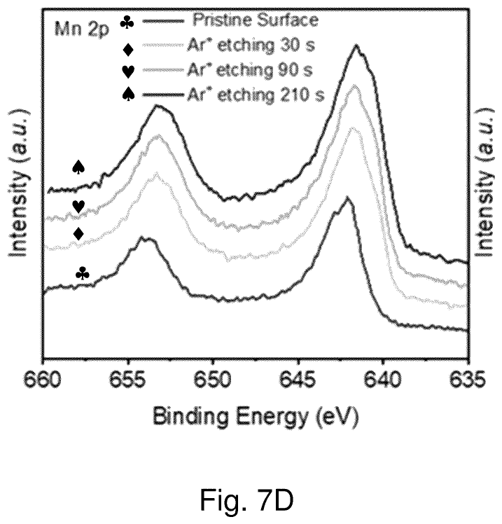

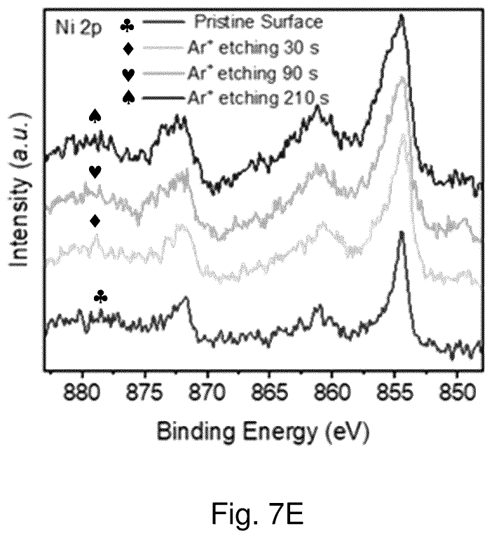

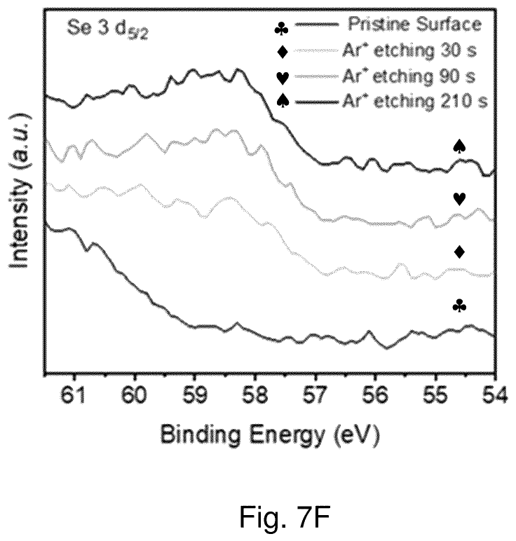

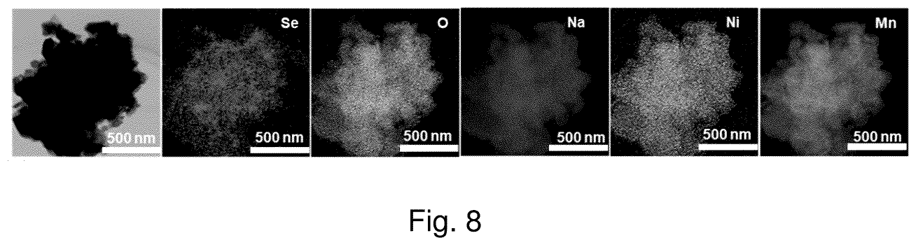

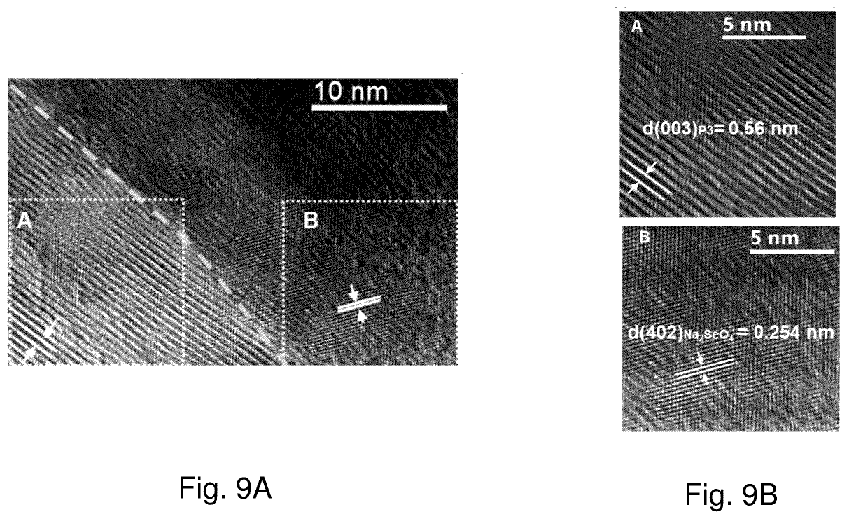

The transmission electron microscopy (TEM) energy dispersive spectroscopy (EDS) mapping of the NMNO/NSO-2 and XPS spectra of NMNO/NSO-2 powders with Ar⁺ etching at different depths (FIGS. 7A-7F) demonstrates the uniform distribution of each element (FIG. 8), indicating the homogeneous integration between the NSO and the P3-NMNO phases. From the high-resolution transmission electron microscopy (HRTEM) images (FIGS. 9A and 9B), the crystal planes located in A and B area exhibit d-spacing of 0.56 and 0.254 nm, corresponding to the (003) plane of P3-NMNO and (402) plane of NSO, respectively, which offers evidence for the formation of mixed-phase structure of NMNO/NSO.

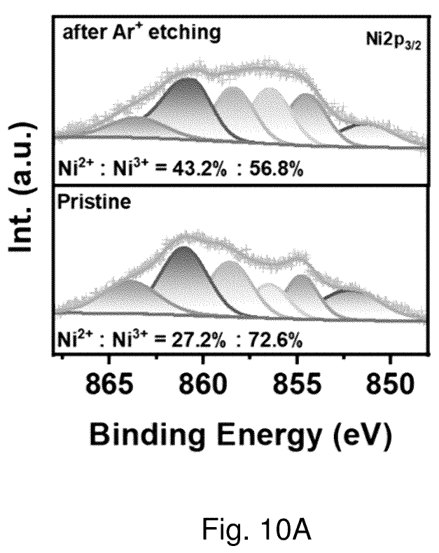

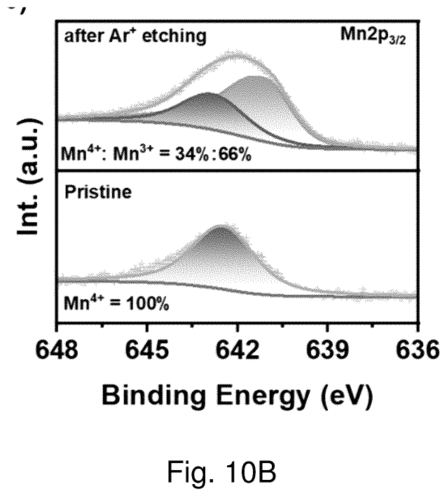

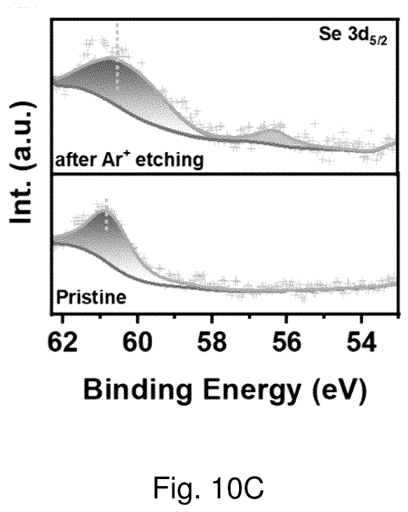

X-ray photoelectron spectroscopy (XPS) was performed to analyze the surface oxidation states of Ni, Mn, and Se in NMNO/NSO. FIGS. 10A-10C displays XPS spectra of Ni 2p_{3/2}, Mn 2p_{3/2}, and Se 3d_{5/2}, respectively. Since the multiple splits appear in the XPS spectra of Ni 2p and Mn 2p, the oxidation states can be analyzed based on their 2p_{3/2} spectra with strong signals. The peaks around 854.76/856.43 eV, 858.53/861.03 eV, and 863.9 eV in Ni 2p_{3/2} XPS spectrum are assigned to Ni²⁺, Ni³⁺, and satellite peaks, respectively. While the peak at 642.48 eV in Mn 2p_{3/2} XPS spectrum and the peak at 60.7 eV in Se 3d_{5/2} XPS spectrum are assigned to Mn⁴⁺ and Se⁶⁺, respectively.

### Example 3

### Electrochemical Properties of NMNO/NSO-1/2/3

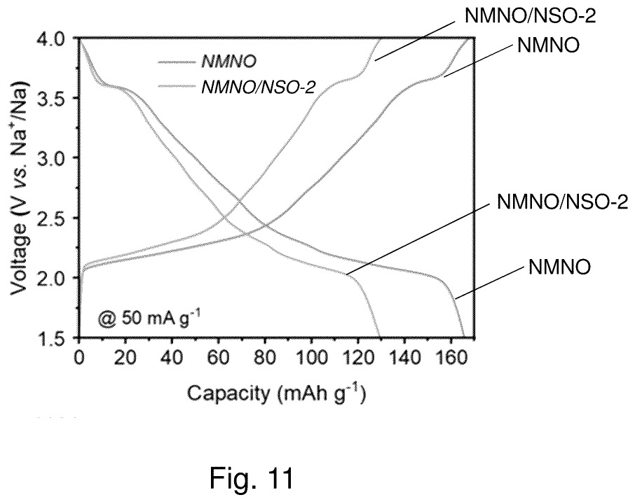

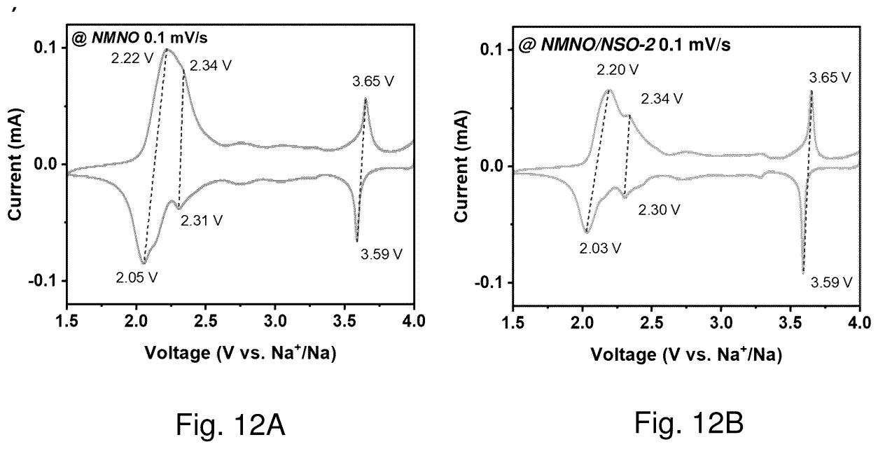

Electrochemical behaviors of NMNO and NMNO/NSO cathodes are evaluated in half-cells over a voltage range of 1.5-4.0 V. FIG. 11 displays selected charge/discharge curves for NMNO and NMNO/NSO-2 cathodes at a current density of 50 mA g⁻¹. The similar plateaus in the charge/discharge curves of NMNO and NMNO/NSO-2 indicate the same redox reactions. Consistently, the similar redox peaks of NMNO and NMNO/NSO-2 cathodes can also be observed in their CV profiles (FIGS. 12A and 12B). The splitting redox peaks around 2.2/2.0 V and 2.3/2.3 V are associated with the redox pairs of Mn³⁺/Mn⁴⁺, which probably ascribes to the P3-O3 phase transition. The redox peaks at 3.65/3.59 V are relative to the redox pair of Ni²⁺/Ni³⁺.

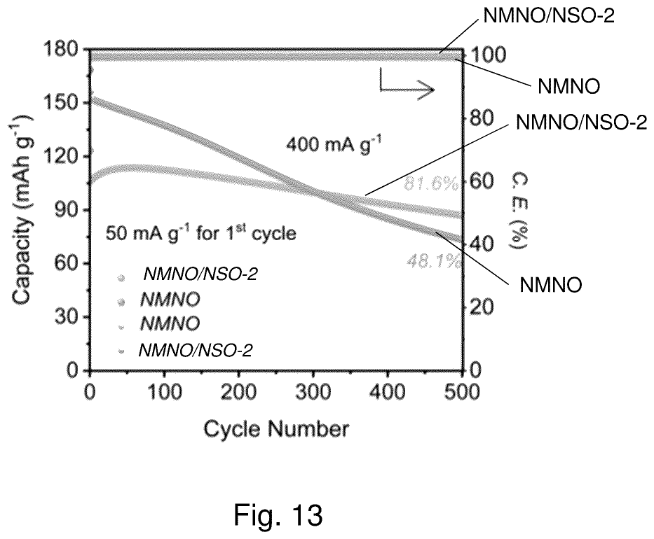

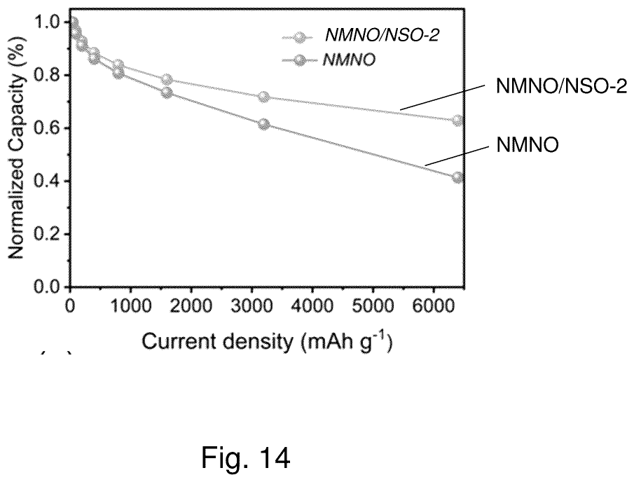

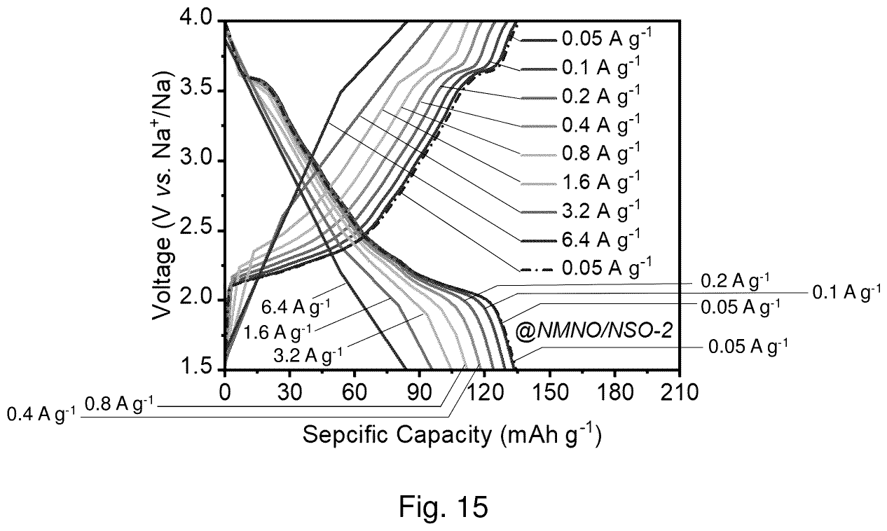

The lower initial capacity of the NMNO/NSO-2 cathode is attributed to the lower content of active materials (FIG. 13). FIG. 14 shows a comparison plot of the normalized capacity at current densities ranging from 50 to 6400 mA g⁻¹ for the NMNO/NSO-2 and the NMNO cathodes. The NMNO/NSO-2 cathode presents a higher capacity retention than the NMNO cathode. As displayed in FIG. 15, the NMNO/NSO-2 cathode delivers discharge capacities of 133.5, 129.2, 123.9, 118.1, 111.9, 104.6, 95.8, and 83.9 mAh g⁻¹ under 50, 100, 200, 400, 800, 1600, 3200, and 6400 mA g⁻¹, respectively.

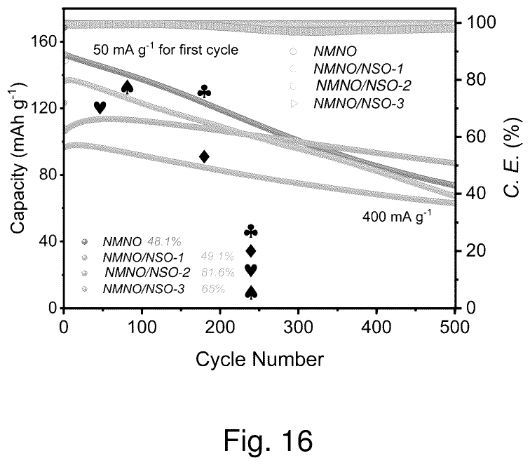

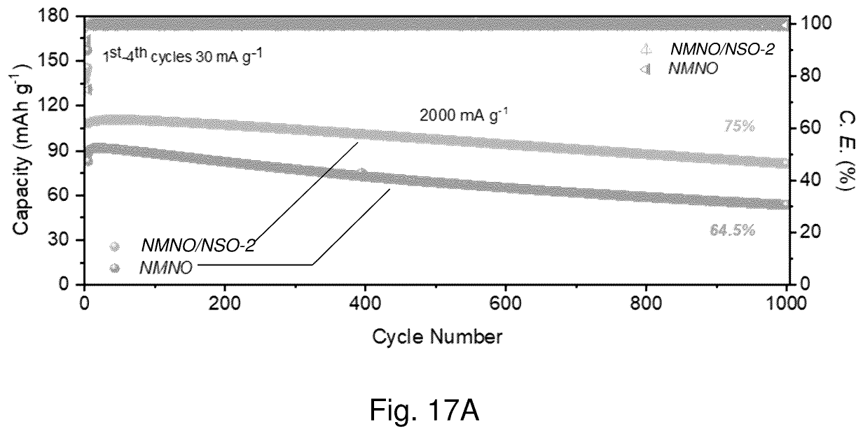

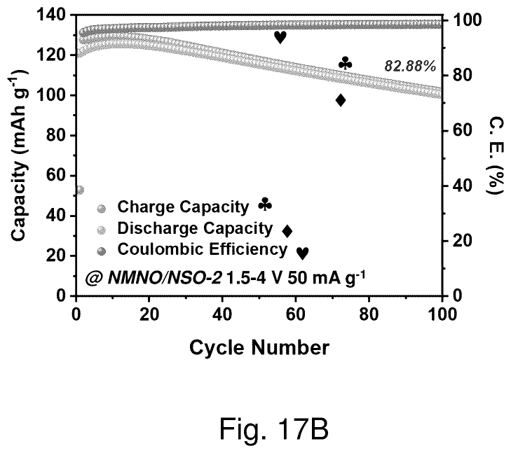

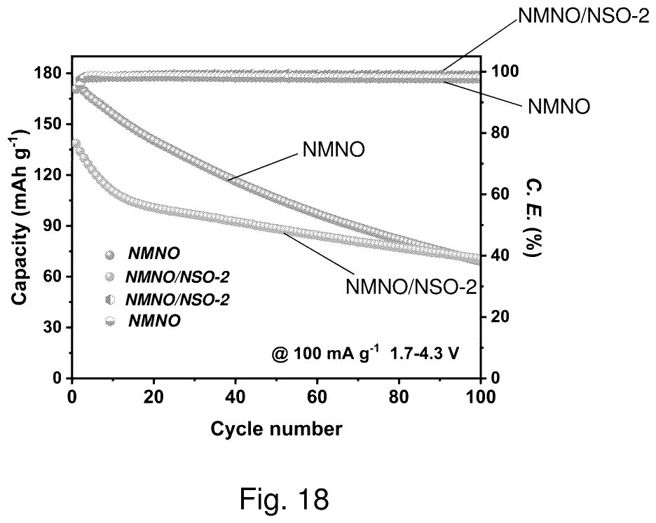

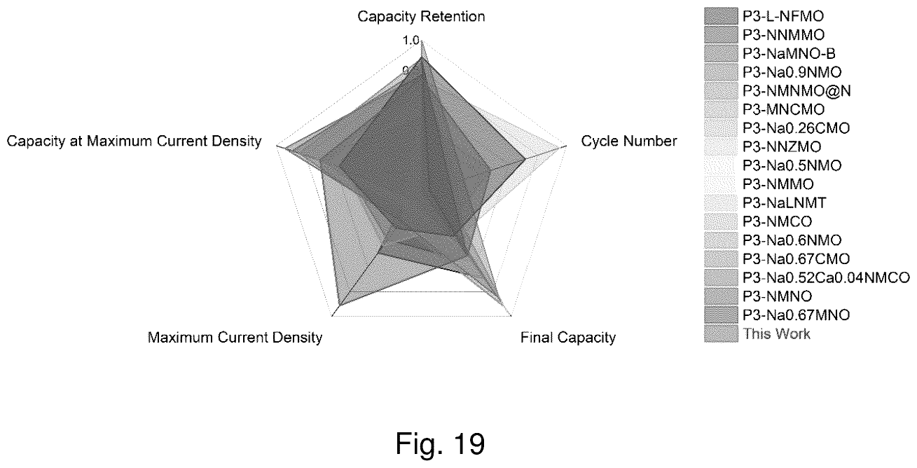

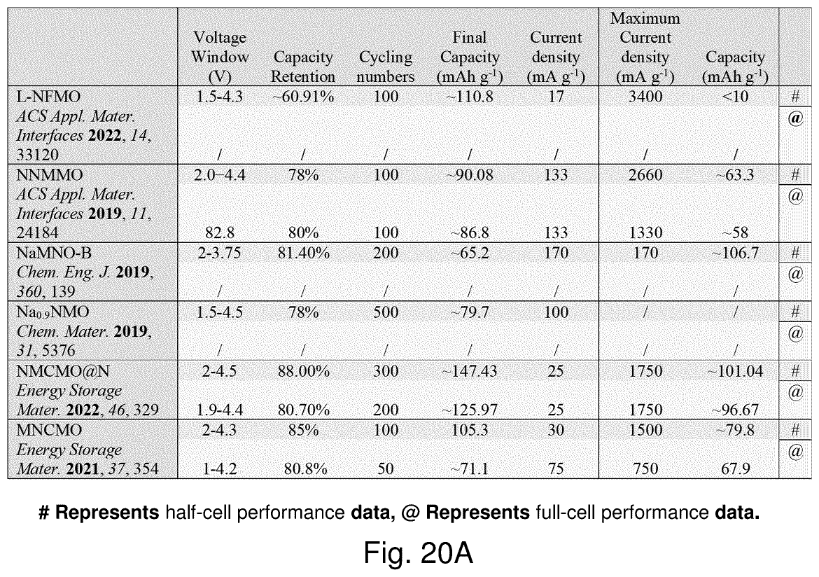

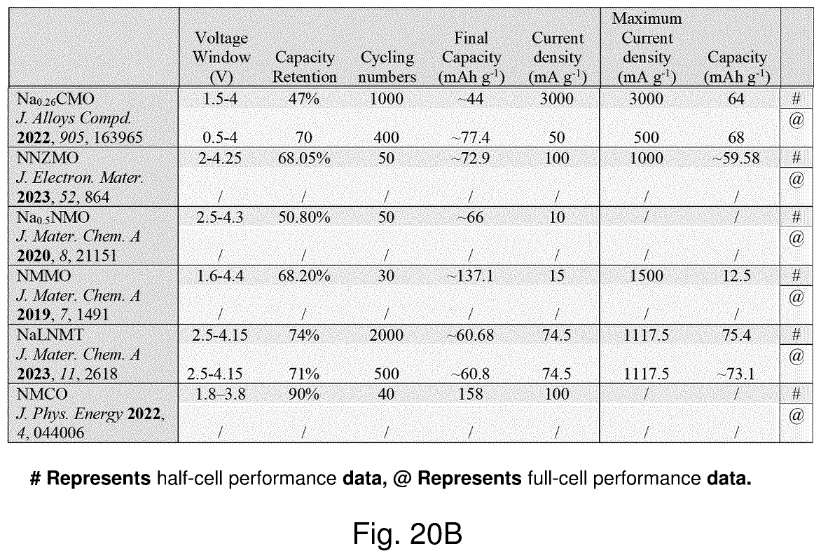

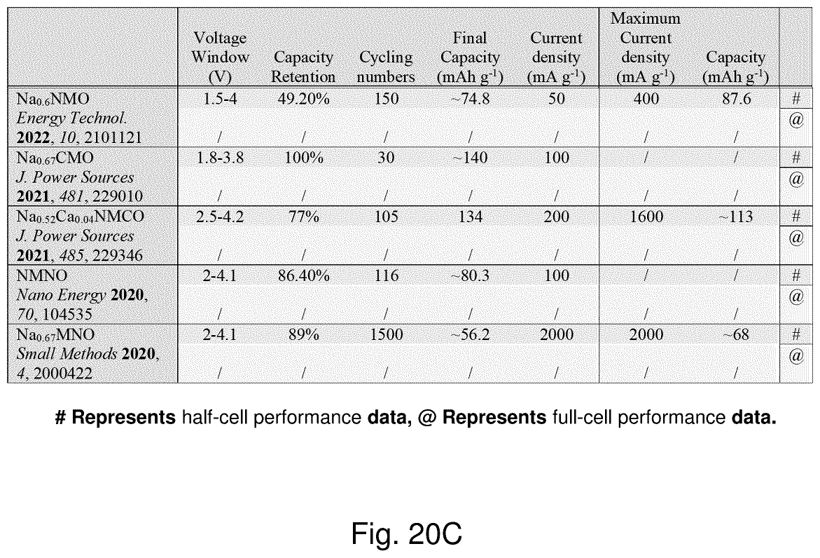

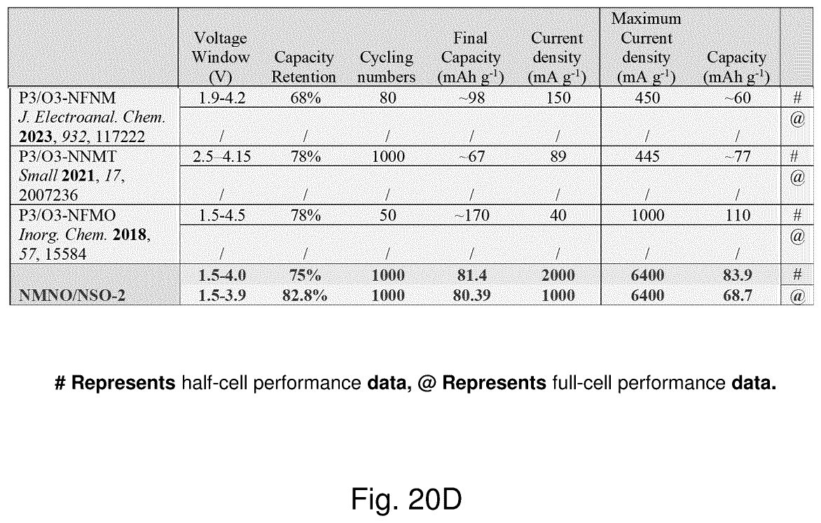

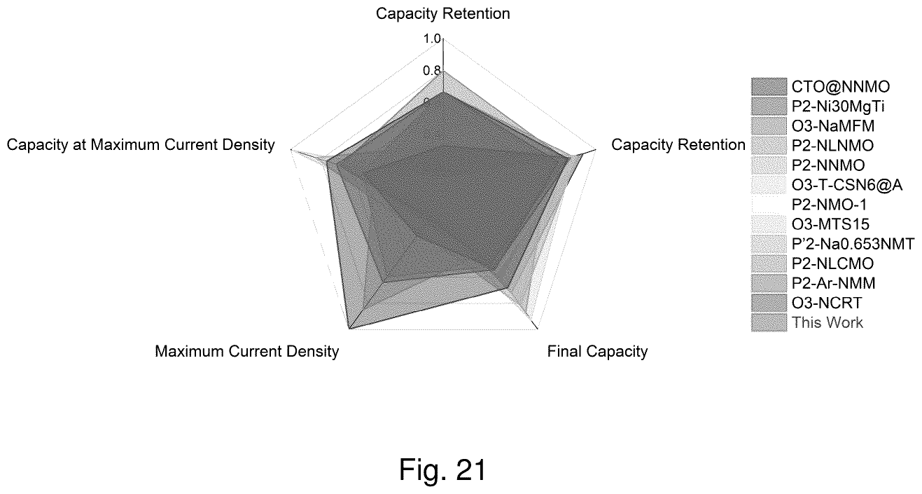

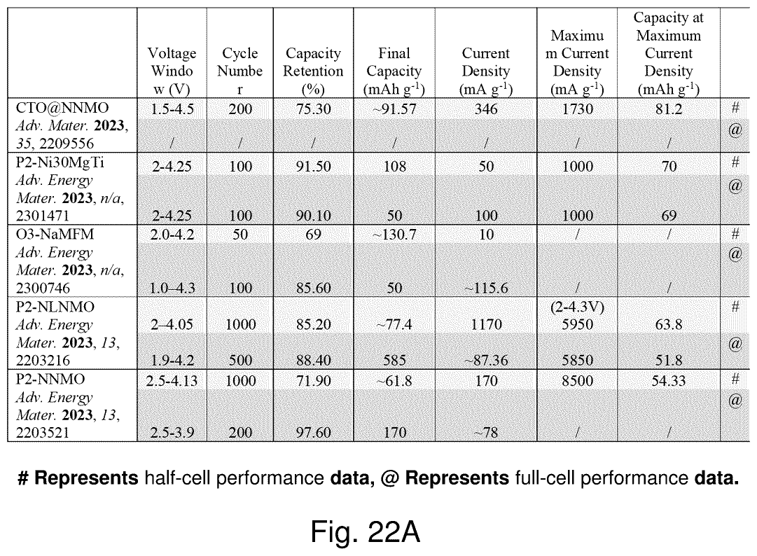

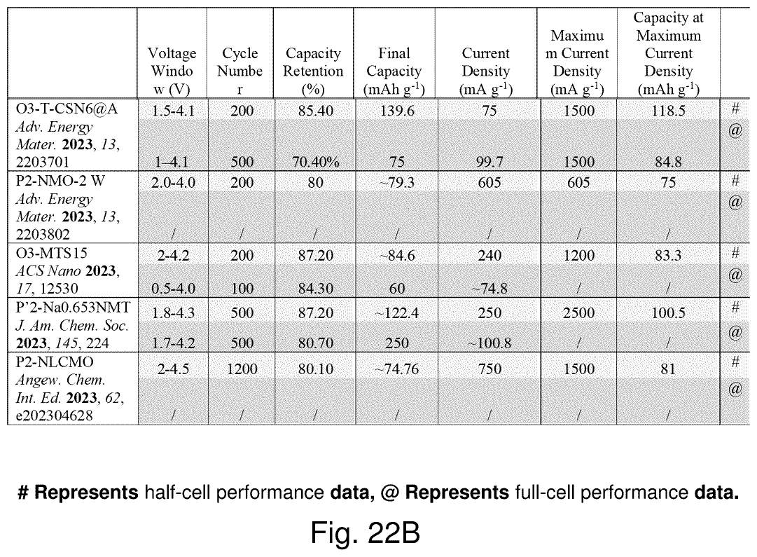

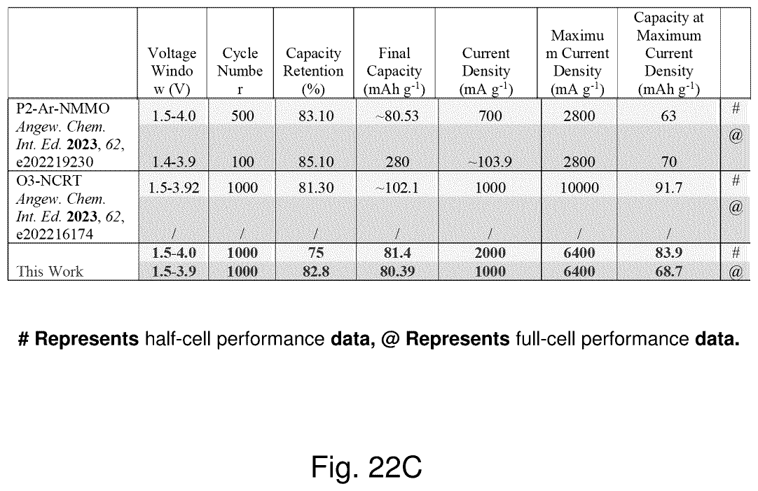

For long-cycling lifespan comparison between NMNO/NSO-2 and NMNO in FIGS. 13 and 16, NMNO/NSO-2 cathode exhibits a superior cycling stability that still maintains 81.6% capacity retention over 500 cycles at a current density of 400 mA g⁻¹, without counting the first activation cycle at 30 mAg⁻¹. In contrast, the NMNO cathode exhibits fast capacity fading with only 48.1% capacity retention after 500 cycles. While, the NMNO/NSO-1 and NMNO/NSO-3, respectively, maintain 49.1% and 65% capacity retention, indicating that the content of NSO significantly impacts their electrochemical performance. Furthermore, the NMNO/NSO-2 cathode was also tested at 2000 mA g⁻¹ and 50 mA g⁻¹ to investigate the extended cycling capability. As shown in FIGS. 17A and 17B, the NMNO/NSO-2 cathode demonstrates excellent long-cycling performance with 75% capacity retention over 1000 cycles at 2000 mA g⁻¹ and 82.88% capacity retention over 100 cycles at 50 mA g⁻¹. Besides, the NMNO/NSO-2 cathode still displays higher cycling stability than the NMNO cathode, even charging to higher voltages of 1.7-4.3 V (FIG. 18). It is believed that the rate capability and cyclic stability of the NMNO/NSO-2 exhibit recorded high-rate capability and superior cycling stability among all reported P3-type cathodes (FIGS. 19 and 20A-20C). It is also believed that the rate capability and cyclic stability of the NMNO/NSO-2 are comparable with some reported P2- and O3-type cathodes (FIGS. 21 and 22A-22C).

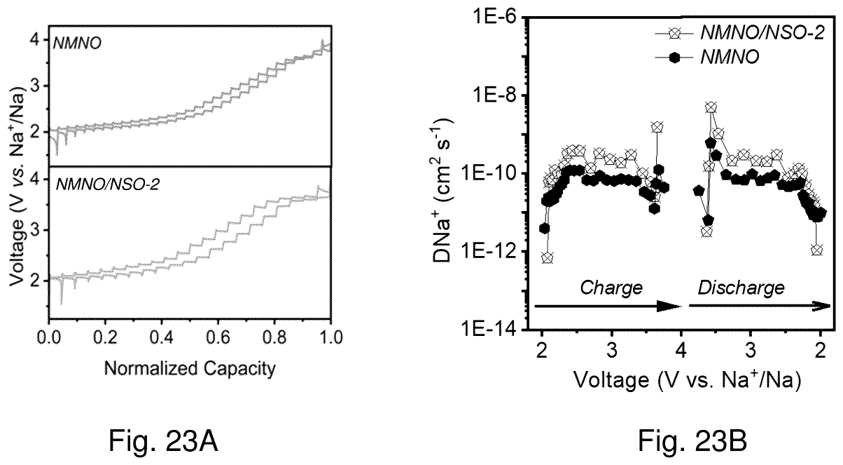

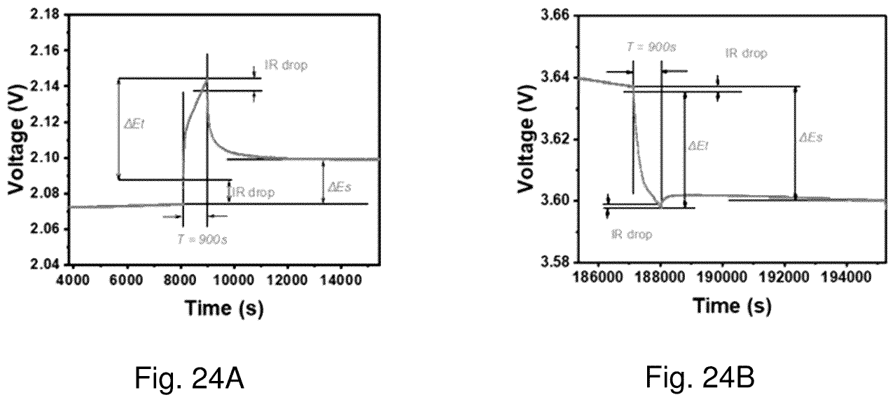

To investigate the effect of the mixed-phase structure of P3-NMNO with NSO on kinetic behaviors, GITT (Galvanostatic Intermittent Titration Technique) measurements were performed (FIG. 23A), and Na⁺ diffusion coefficients (D_{Na}+) were calculated (FIG. 23B) as described herein (FIGS. 24A and 24B and Equation 1). The sharply decreased diffusion coefficients D_{Na+} in FIG. 23B occurred at 2.3/2.0 V and 3.65/3.6 V in FIG. 23A, corresponding to the biphasic phase transitions. In addition, the Na⁺ diffusion coefficients of NMNO/NSO-2 are significantly higher than that of NMNO during the charging/discharging process in FIG. 23B, indicating that the heterogeneous structure of NMNO/NSO-2 has better Na⁺ transport kinetics.

### Example 4

### DFT Calculations

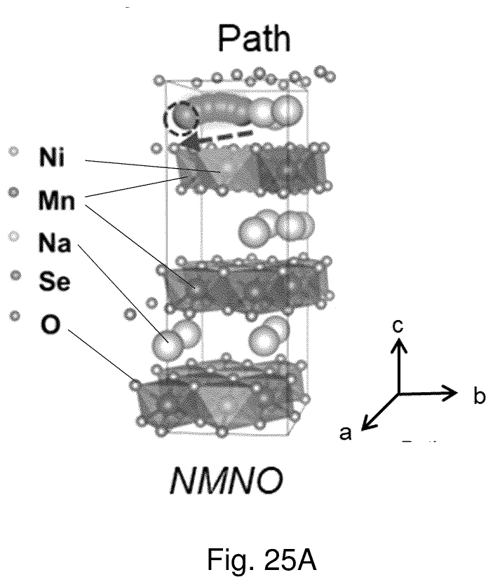

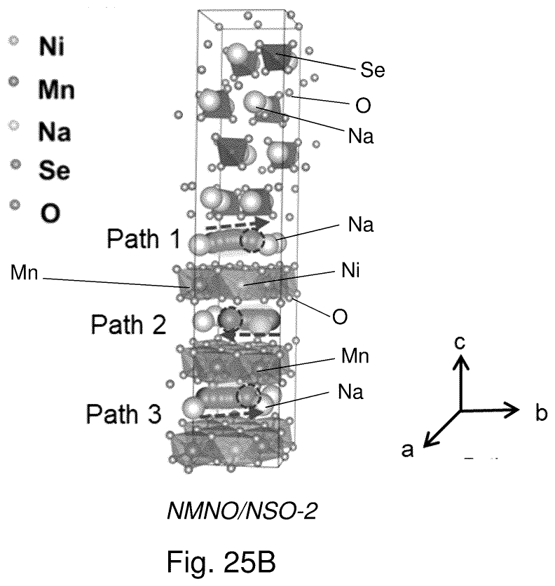

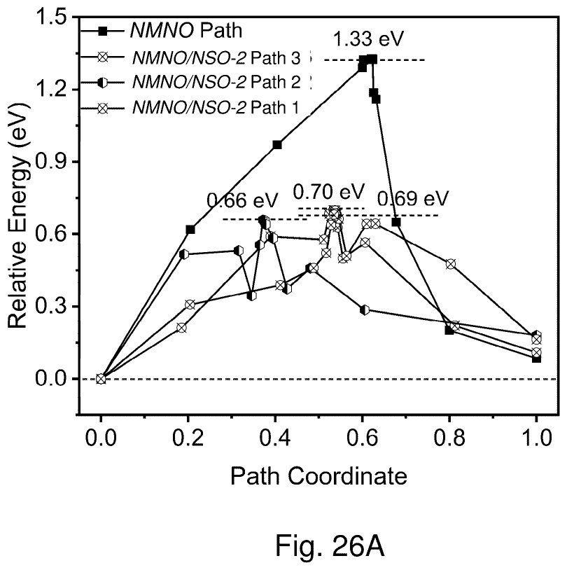

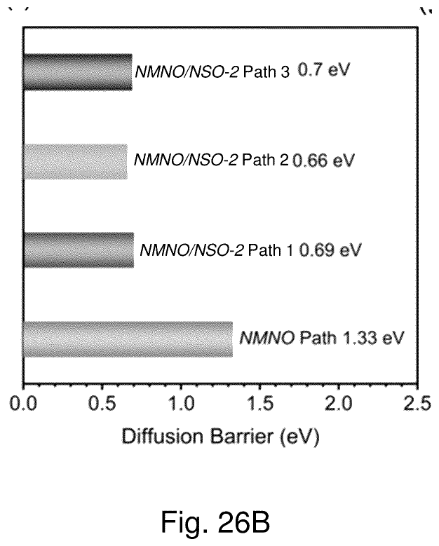

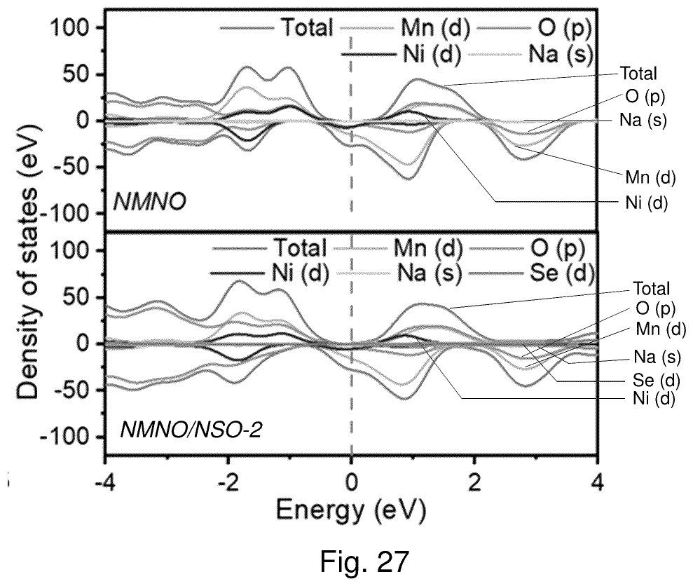

Density Functional Theory (DFT) calculations based on linear synchronous transit/quadratic synchronous transit (LST/QST) method were conducted to investigate diffusion barriers from one Na site to the nearest vacancy site. Local environments of Na⁺ in NMNO and NMNO/NSO-2 are considered as shown respectively in FIGS. 25A and 25B. Three different Na⁺ diffusion pathways were considered in NMNO/NSO-2 representing Na⁺ ions right on, nearest to, and next nearest to the NMNO/NSO-2 interface. Without the NMNO/NSO-2 interface, it is believed that only one pathway is available for NMNO. It is interesting to note that all three pathways in NMNO/NSO-2 exhibits much lower diffusion barrier energies (0.69, 0.66, 0.70 eV along path 1, 2, and 3, respectively) compared to that for NMNO (1.33 eV) (FIGS. 26A and 26B). These agree well with the higher diffusion coefficients of NMNO/NSO-2 as shown in FIG. 23B. It is believed that the lowered diffusion barriers are probably due to invoking a built-in electric field in the interface between the mixed-phase structure. The asymmetric charge distributions between NMNO and NSO make the carriers autonomous migration to achieve the Fermi level reaching balance, which boosts the charge transfer. As shown in FIG. 27, the DOS of NMNO/NSO-2 is increased at the Fermi level compared with that of NMNO, which indicates the electronic conductivity is significantly enhanced. Additionally, the energetic density of states (DOS) of NMNO/NSO-2 is lower than that of NMNO, indicating higher structural stability of NMNO/NSO-2.

### Example 5

### Mechanism of Enhanced Cycling Stability of NMNO/NSO-2

To reveal the mechanism of the enhanced cycling stability for the mixed-phase structure NMNO/NSO-2, structural evolution upon the first charge/discharge cycle for the NMNO and NMNO/NSO-2 cathodes was studied via in-situ XRD technique.

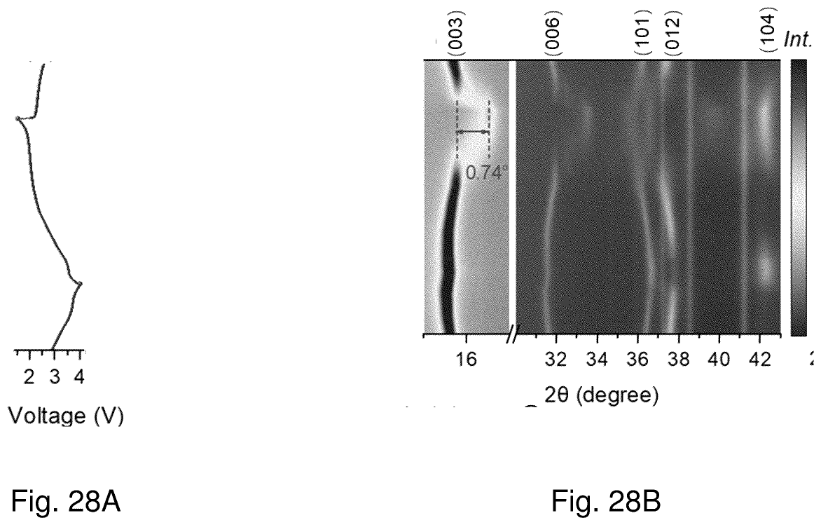

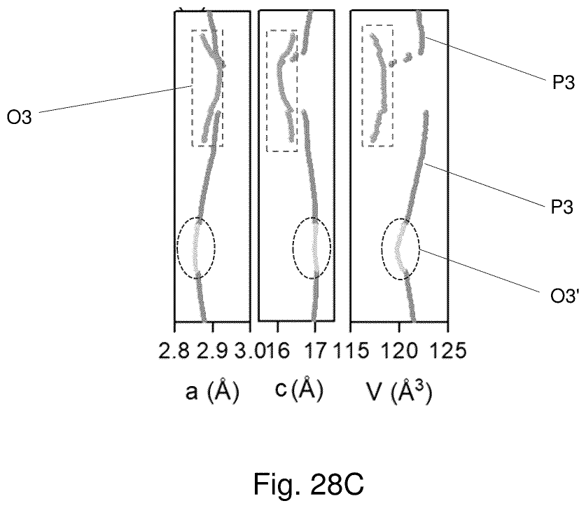

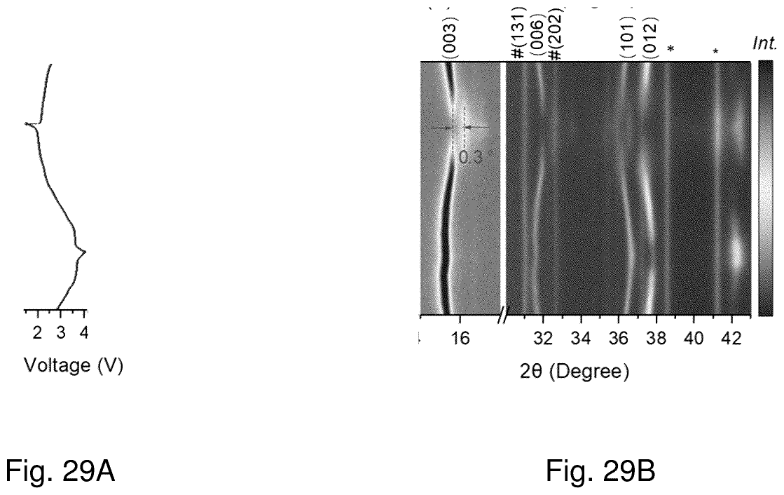

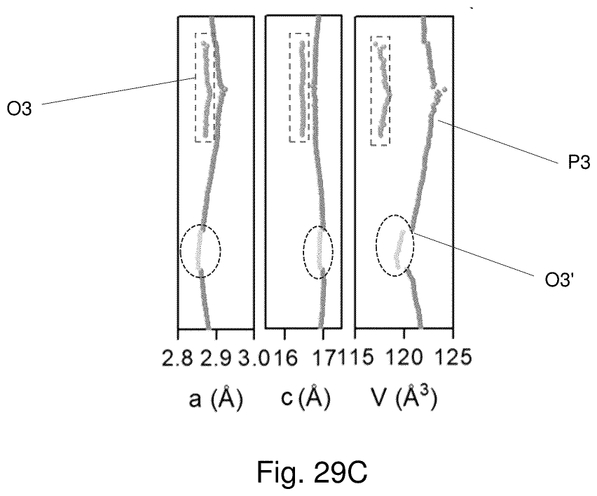

For the charging process, NMNO and NMNO/NSO-2 cathodes exhibit similar trends from P3 solid-solution phase transition to the reversible P3-O3′ phase transition. As shown in FIGS. 28A-28C and 29A-29C, the (003)/(006) peaks continuously shift towards the lower angles accompanied by the c lattice parameters increasing, corresponding to the expansion of interlayer spacing of Na layer along the c axis. The (101)/(012) peaks shift to a higher angle with the lattice parameter a/b decreasing, indicating the contraction of the ab plane. However, (003)/(006) peaks shift back toward a higher angle abnormally with more Na⁺ extracted. Meanwhile, the intensity of (101)/(104) peaks increases and the (012) peak diminishes, suggesting that biphasic transitions of P3-O3′ replace the solid-solution phase transition of P3.

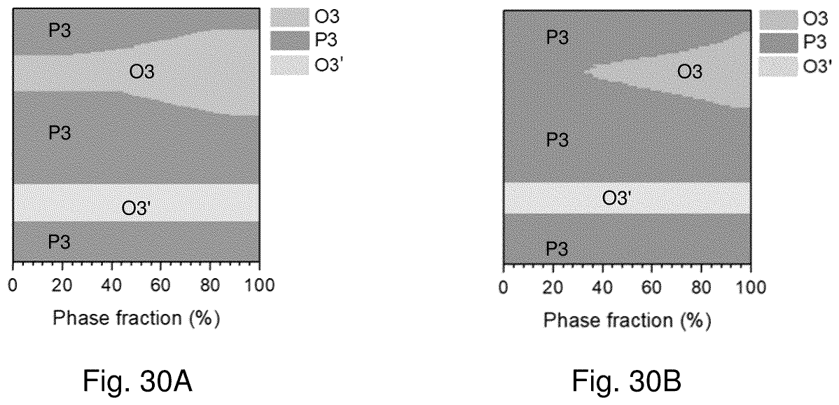

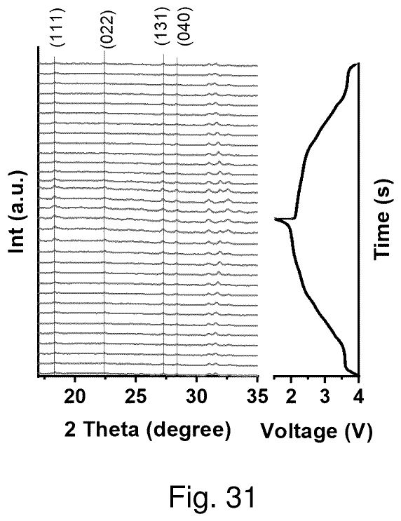

Upon discharging, NMNO and NMNO/NSO-2 cathodes undergo similar reverse changes relative to the charging process, except for deep sodiation states. With more Na⁺ inserting, the intensity of (003)/(006) peaks for NMNO and NMNO/NSO-2 cathodes reduced simultaneously, ascribing to the reduced ordering and crystallinity. Additionally, the obvious (104) and disappeared (012) peaks indicate a new O3 phase appearance. Generally, with more sodium ions insertion, the coulomb repulsion between transition metal layers reduces, resulting in the shrinkage along the c-axis. Besides, increasing sodium ion contents in the sodium layer may also increase the repulsion between Na⁺—Na⁺, resulting in the expansion of the ab plane, leading to P3-03 phase transitions. It is observed that the (003) peak of the NMNO cathode shifts around 0.740 to a lower angle when discharging to 1.5 V (FIGS. 28B and 29B), while that of the NMNO/NSO-2 cathode shifts only by ˜0.3°, indicating that the presence of Na₂SeO₄ hinders contraction of the NMNO phase along the c-axis. Thus, the transition-metal layer gliding is inhibited, resulting in the reduced P3-O3 phase transformation (FIGS. 30A and 30B). The characteristic peaks (131)/(202) belonging to the Na₂SeO₄ phase show no significant changes throughout the cycle, indicating that Na₂SeO₄ maintained a stable structure during the charging/discharging processes (FIG. 31). Thus, the stable Na₂SeO₄ phase acts as an inert buffer phase to suppress P3-O3 phase transitions and thus enhances the structural stability upon cycling.

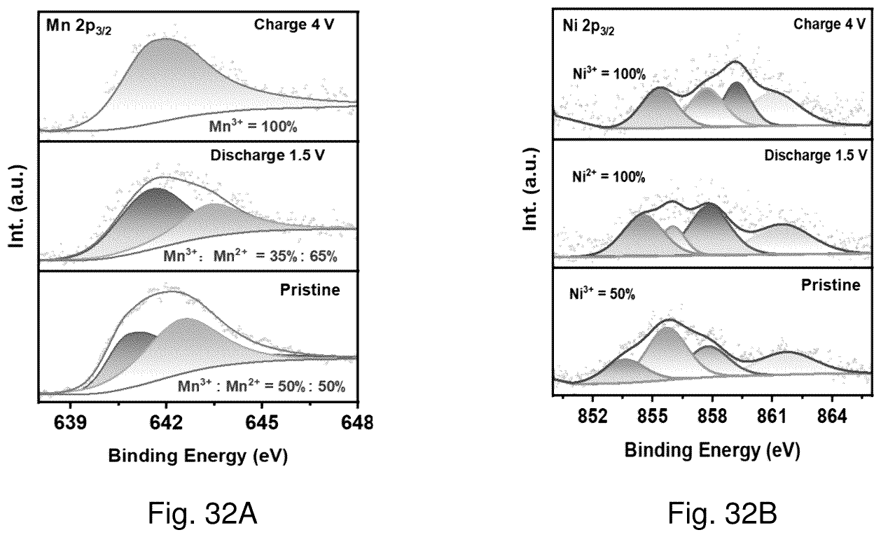

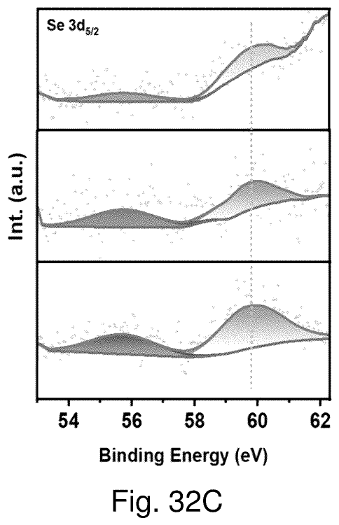

The mechanism was further studied through investigating the redox behaviors of NMNO/NSO-2. In particular, the XPS Ni 2p, Mn 2p, and Se 3d spectra of NMNO/NSO-2 at the pristine, fully charged and fully discharged states were compared. As shown in FIGS. 32A-32C, it demonstrates that Mn and Ni show redox activity with obvious changes in valence state ratios during charge/discharge processes. The Se exhibits no apparent shift in binding energy, indicating that the Na₂SeO₄ is not redox active, consistent with the similar CV curves between NMNO and NMNO/NSO-2, as well as the unchanged in-situ XRD pattern of Na₂SeO₄.

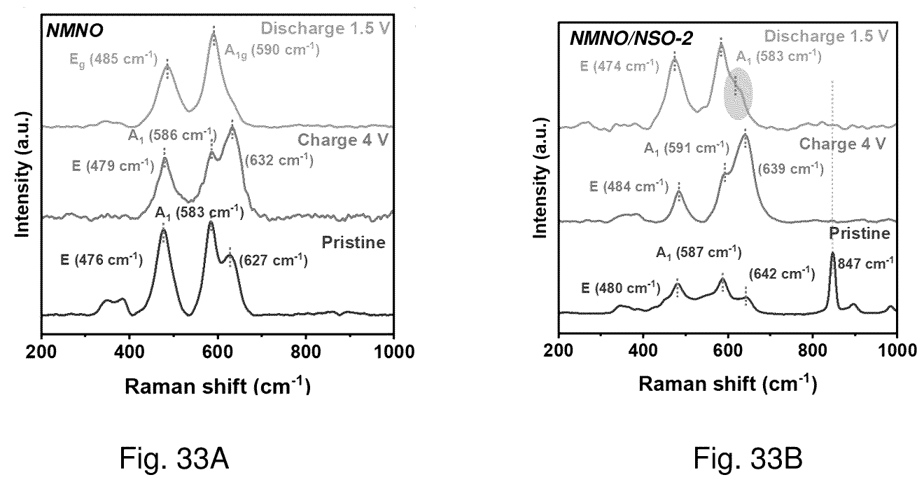

Additionally, ex-situ Raman spectra were performed to study the local structures and bond environment changes for NMNO and NMNO/NSO-2 during the charge/discharge processes. The vibrational modes A₁ (583 cm⁻¹ for NMNO, 587 cm⁻¹ for NMNO/NSO-2) and E (476 cm⁻¹ for NMNO, 480 cm⁻¹ for NMNO/NSO-2) originate from the out-of-plane TM-O (TM=transition metal) stretching and in-plane O-TM-O bending, respectively. Also, Raman bands change around 587/642 cm⁻¹ are generally associated with the John-Teller distortion of MO₆ octahedron, corresponding to the variation of Mn³⁺/Mn⁴⁺ and Ni²⁺/Ni³⁺ redox pairs. Thus, it is believed that the intensity changes probably follow the ratio changes of Mn³⁺/Mn⁴⁺ and Ni²⁺/Ni³⁺ (FIGS. 33A and 33B). Interestingly, the Raman spectra for NMNO and NMNO/NSO-2 exhibit different shift trends and shapes at a fully discharged state. The NMNO cathode only shows two prominent bands at 485 cm⁻¹ and 590 cm¹, which belong to E_{g} and A_{1g} modes corresponding to the characteristics of the O3-type structure (R3m, No. 166). While the NMNO/NSO-2 at full discharged state displays a similar shape to that of the pristine, along with a red shift for the A₁ and E bands, suggesting the well-maintained local structure.

### Example 6

### Full-Cell Performance of NMNO/NSO-2

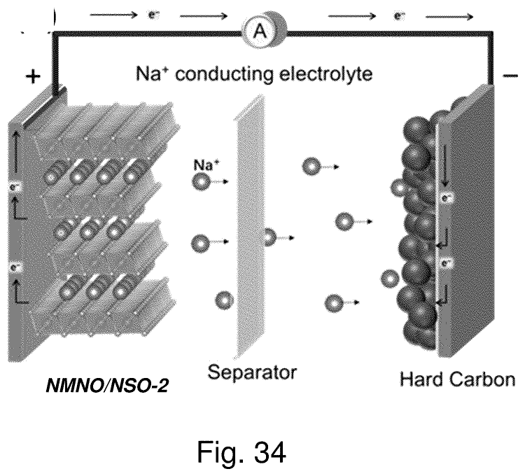

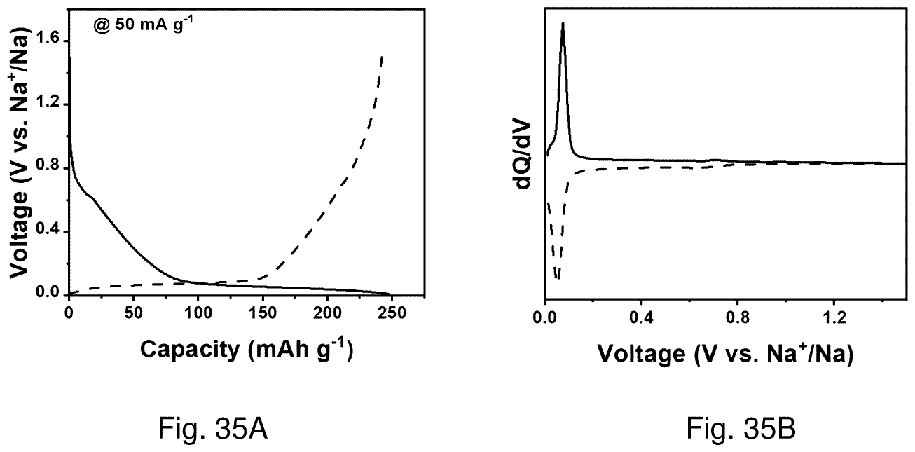

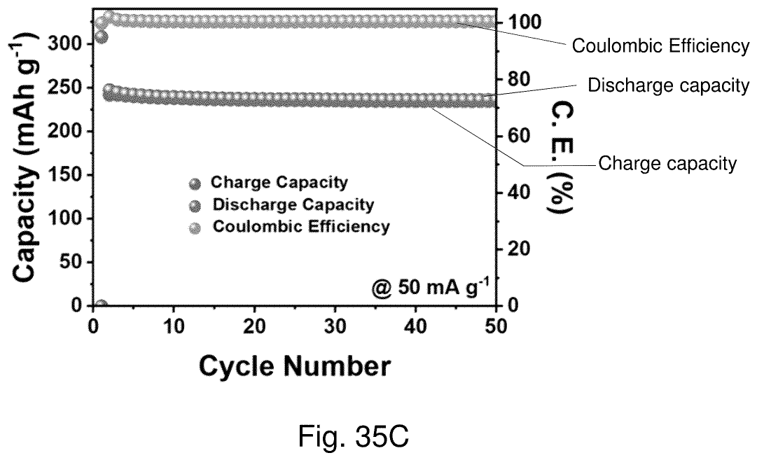

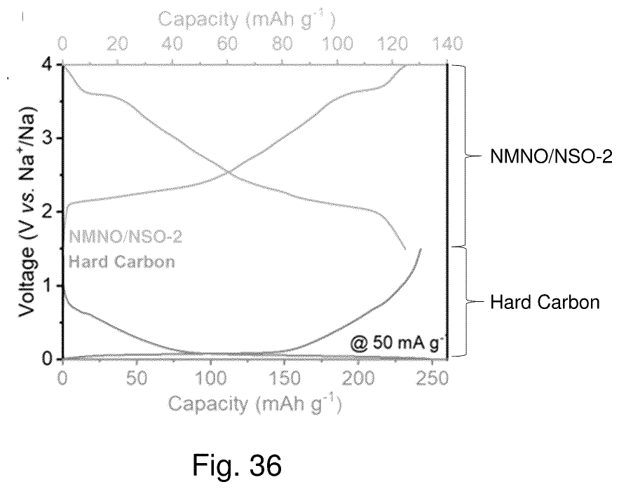

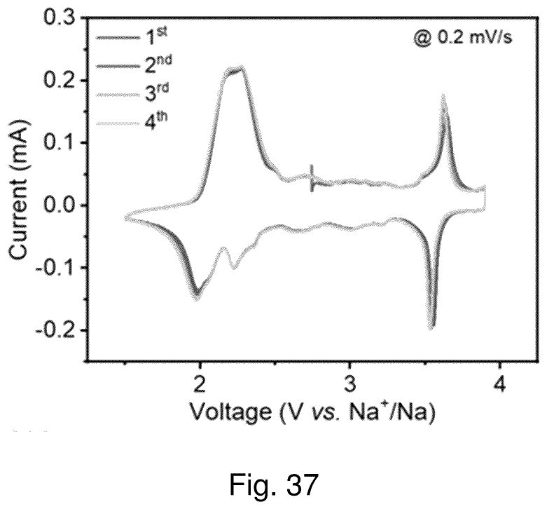

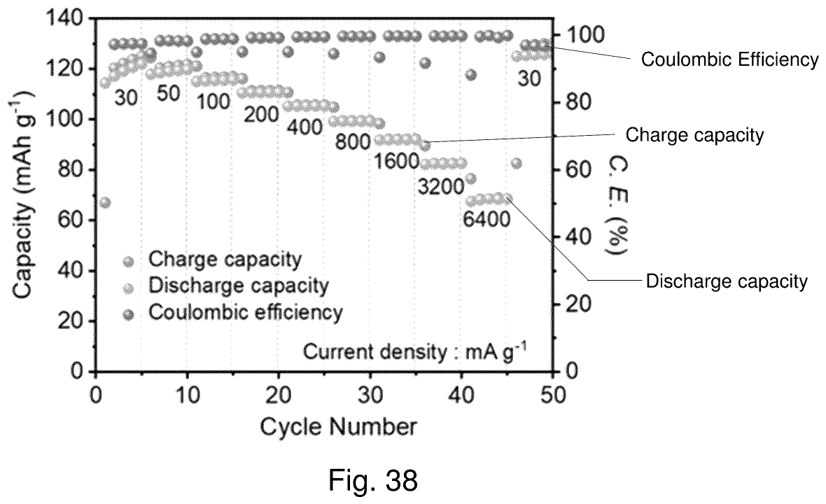

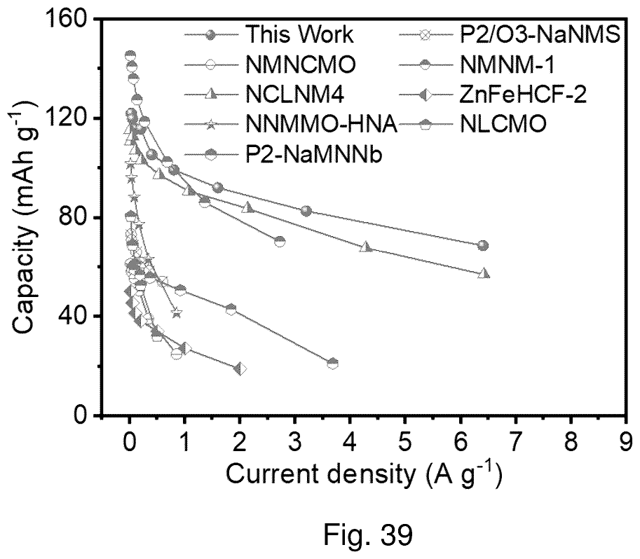

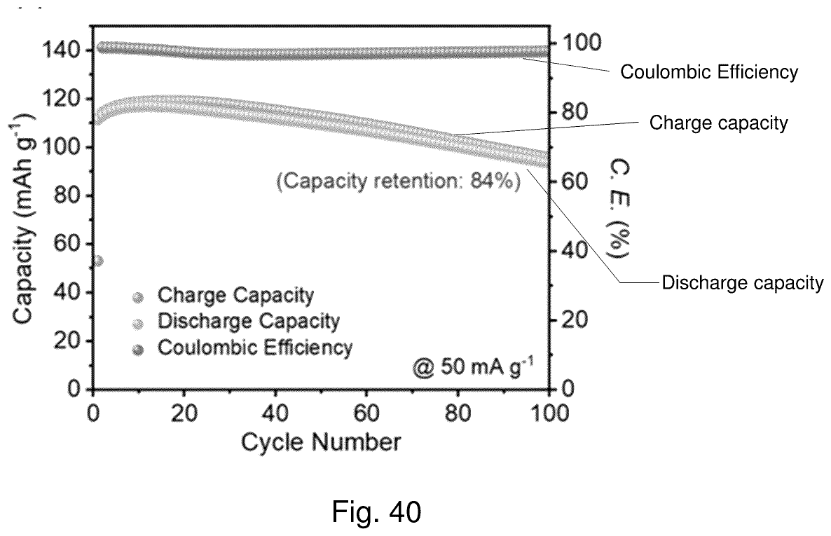

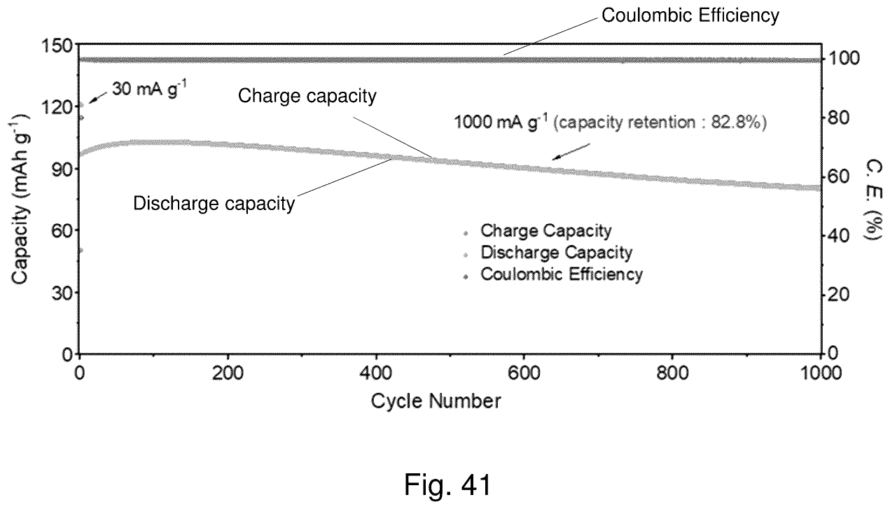

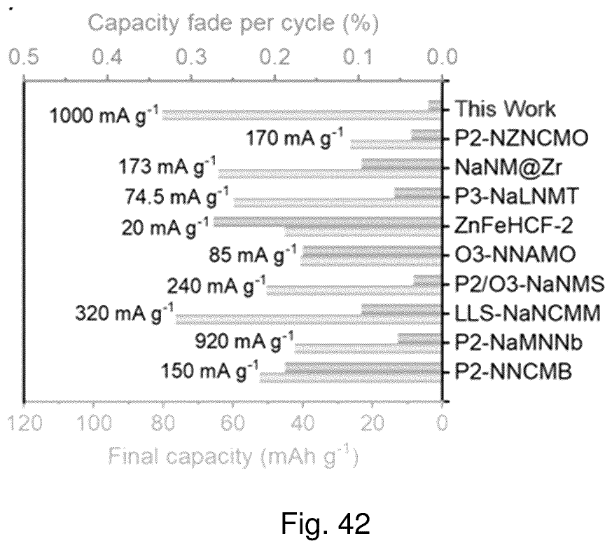

Full-cell performances are tested to verify the feasibility of practical applications of NMNO/NSO-2. The full-cell is based on NMNO/NSO-2 cathode and pre-sodiated hard carbon anode (FIG. 34). The hard carbon anode delivers a reversible capacity of 248 mAh g⁻¹ at 50 mA g⁻¹ (FIGS. 35A-35C). The active mass ratio of the cathode and anode was optimized as 1.9:1 and the voltage window set from 1.5 to 3.9 V according to the delivered reversible capacity of the cathode and the anode in FIG. 36. The CV profiles for the first four cycles are well overlapped (FIG. 37), demonstrating good reversibility of this NMNO/NSO-2/pre-sodiated hard carbon full-cell. The rate capability of this full-cell with the current densities ranging from 30 mA g⁻¹ to 6400 mA g⁻¹ is illustrated in FIG. 38. Even at 6400 mA g⁻¹, the full-cell still delivers 68.7 mAh g⁻¹ capacity corresponding to a high-power density of 78.6 W Kg⁻¹, demonstrating ultrahigh rate performance. Compared with the reported sodium-ion full-cells, the full-cell in this work shows higher capacity at high current density and good capacity retentions with increasing current densities (FIG. 39). Impressively, this full-cell maintains 84% and 82.8% capacity retention at 50 mA g⁻¹ and 1000 mA g⁻¹ over 100 and 1000 cycles, respectively (FIGS. 40 and 41). As shown in FIG. 42, this full-cell exhibits superior cycling stability to those of reported full-cell devices, achieving the lowest per cycle fades percentage and the highest remains capacity, suggesting promising practical applications potential of the full-cell in this work.

The invention has been given by way of example only, and various other modifications of and/or alterations to the described embodiment may be made by persons skilled in the art without departing from the scope of the invention as specified in the appended claims.

1. An electrode material for a sodium-ion battery comprising a mixed-phase structure of sodium nickel-manganese oxide associated with sodium selenate, wherein the sodium nickel-manganese oxide has a general formula of NaₓNi_{y}Mn_{z}O₂, wherein 0.3<x<0.95, 0<y<0.5, 0.5<z<1, and y+z=1.

2. The electrode material as claimed in claim 1, wherein the sodium nickel-manganese oxide has a layered structure and is arranged in a P3-type (ABBCCA) stacking lattice.

3. The electrode material as claimed in claim 2, wherein the sodium nickel-manganese oxide is arranged as a hexagonal lattice.

4. The electrode material as claimed in claim 3, wherein the hexagonal lattice has a space group of R3m.

5. The electrode material as claimed in claim 1, wherein the sodium selenate is arranged as an orthorhombic lattice.

6. The electrode material as claimed in claim 5, wherein the orthorhombic lattice has a space group of Fddd.

7. The electrode material as claimed in claim 1, wherein the mixed-phase structure includes an interface formed by the sodium selenate and the sodium nickel-manganese oxide.

8. The electrode material as claimed in claim 7, wherein the sodium selenate is redox inert and is resistant to structural change during charging and discharging cycle, thereby suppressing P3-O3 phase transition of the sodium nickel-manganese oxide during the charging and discharging cycle.

9. The electrode material as claimed in claim 1, wherein the sodium nickel-manganese oxide and the sodium selenate have a phase fraction ratio of >50 wt. %.

10. The electrode material as claimed in claim 9, wherein the sodium nickel-manganese oxide is about 83 wt. % to about 90 wt. % of the mixed-phase structure.

11. The electrode material as claimed in claim 10, wherein the sodium nickel-manganese oxide is about 83.8 wt. %, about 86.7 wt. % or about 89.8 wt. % of the mixed-phase structure.

12. The electrode material as claimed in claim 9, wherein the sodium selenate is about 7 wt. % to about 14 wt. % of the mixed-phase structure.

13. The electrode material as claimed in claim 12, wherein the sodium selenate is about 7.3 wt. %, about 11.3 wt. % or about 13.6 wt. % of the mixed-phase structure.

14. The electrode material as claimed in claim 9, wherein the mixed-phase structure further includes NiO which is about 2 wt. % to about 3 wt. % of the mixed-phase structure.

15. The electrode material as claimed in claim 1, wherein the mixed-phase structure comprises Na_{0.47}Ni_{0.23}Mn_{0.77}O₂/Na₂SeO₄, Na_{0.45}Ni_{0.2}Mn_{0.8}O₂/Na₂SeO₄, Na_{0.53}Ni_{0.22}Mn_{0.78}O₂/Na₂SeO₄ or a combination thereof.

16. A method for preparing the electrode material as claimed in claim 1, comprising the steps of:
providing a solid mixture comprising a sodium source, a manganese source, a nickel source, and a selenium source;
heating the solid mixture in a furnace at a first temperature under a predetermined atmosphere and pressure;
heating the solid mixture at a second temperature, which is different from the first temperature, to obtain the electrode material; and
isolating the electrode material at a third temperature which is different from the first temperature and the second temperature.

17. The method as claimed in claim 16, wherein both heating steps are carried out under a reduced pressure and an O₂ atmosphere, or under an atmospheric pressure and an air atmosphere.

18. The method as claimed in claim 16, wherein the step of isolation includes cooling down the electrode material to the third temperature and storing it under an inert gas atmosphere.

19. The method as claimed in claim 16, wherein the sodium source, the manganese source, the nickel source, and the selenium source are CH₃COONa, Mn₂O₃, NiO, and Se, respectively.

20. The method as claimed in claim 16, wherein the sodium source, the manganese source, the nickel source, and the selenium source have a mole ratio of Na:Mn:Ni:Se=9:10:3:1-3.

21. The method as claimed in claim 16, further comprising the step of increasing temperature of the furnace to the first temperature at a rate of about 1-5° C./min, followed by maintaining the furnace at the first temperature for about 2-6 hours.

22. The method as claimed in claim 16, further comprising the step of increasing the first temperature to the second temperature at a rate of about 1-5° C./min, followed by maintaining the tube furnace at the second temperature for about 10-15 hours.

23. The method as claimed in claim 16, wherein the first temperature the second temperature, and the third temperature are about 300-400° C. about 650-750° C., and about 190-210° C., respectively.

24. A sodium-ion battery comprising an electrode comprising the electrode material as claimed in claim 1, wherein the electrode is a cathode.

25. The sodium-ion battery as claimed in claim 24 is a half-coin cell with an anode of sodium metal.

26. The sodium-ion battery as claimed in claim 24 is a full-coin cell with an anode of pre-sodiated hard carbon.
